(19) United States
(12) Patent Application Publication
(10) Pub. No.: US 2026/0264155 A1
(43) Pub. Date: Sep. 10, 2026

(54) GUTTERING ASSEMBLY FOR COLD SAW SYSTEM

(71) Applicant: Precision Automation, Inc., Vancouver, WA (US)

(72) Inventors: Minh Dat Ba Tran, Portland, OR (US); Casey Bolthouse, Vancouver, WA (US); Nathan Yasuda, Portland, OR (US); Michael Hojnacki, Portland, OR (US)

(73) Assignee: Precision Automation, Inc., Vancouver, WA (US)

(21) Appl. No.: 19/431,823

(22) Filed: Dec. 23, 2025

Related U.S. Application Data
(63) Continuation-in-part of application No. 19/073,807, filed on Mar. 7, 2025.

(51) Int. Cl. B23D 47/02; B23D 59/02

(52) U.S. Cl. CPC B23D 47/025; B23D 59/02

(57) ABSTRACT

In one aspect, a system can include a saw table defining a saw table surface and having a coolant reservoir; a saw coupled to the saw table; a table defining a table surface and having a plurality of post brackets, wherein the table surface can be coplanar with the saw table surface; a guttering assembly coupled to the table, wherein the guttering assembly can include a trough support coupled to a corresponding one of the post brackets and a trough piece coupled to the trough support. The trough piece can form a trough configured to collect coolant draining off the table surface and channel the coolant to the coolant reservoir.

### CROSS-REFERENCE TO RELATED APPLICATION

This application is a continuation-in-part of U.S. Patent Application No. 19/073,807, filed on Mar. 7, 2025, which is incorporated by reference herein in its entirety.

### FIELD

The present disclosure relates to cutting saws, specifically to automatic cold saws for cutting ferrous metals.

### BACKGROUND

A cold saw is a type of cutting saw configured to make a cut in a workpiece. As the cold saw cuts into the workpiece, the cold saw generates chips and transfers heat generated by the cutting action to the chips. By transferring the generated heat to the chips rather than to the cutting surface of the workpiece, cold saws can reduce heat buildup in the workpiece, thereby reducing the occurrence of material discoloration, burr formation, dust generation, and spark generation as compared to other types of cutting saws (e.g., abrasive saws). Thus, in these ways, cold saws can produce accurate cuts with high-quality finishes.

Accordingly, there is a pressing need for improved cold saws.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one aspect, a system can include a saw table defining a table surface; a saw cabinet mounted on the saw table, wherein the saw cabinet can include a top surface and an aperture in the top surface; a damper extending at least partially through the aperture; a saw coupled to the damper and disposed within the saw cabinet; a clamp configured to releasably engage a workpiece disposed on the table surface of the saw table; at least one of an infeed table defining an infeed table surface, wherein the infeed table surface can be coplanar with the table surface of the saw table, and an outfeed table defining an outfeed table surface, wherein the outfeed table surface can be coplanar with the table surface of the saw table; and a controller storing instructions in non-transitory memory that, when executed, can cause the controller to: engage the clamp; advance the saw from a resting position to a cutting position; retract the saw from the cutting position to the resting position; and disengage the clamp.

In one aspect, a system can include a saw table defining a table surface; a saw cabinet coupled to the saw table; a damper coupled to the saw cabinet; a saw coupled to the damper and disposed within the saw cabinet; and a controller storing instructions in non-transitory memory that, when executed, can cause the controller to: advance the saw from a resting position to a damper activation position; and advance the saw from the damper activation position to a cutting position.

In one aspect, a system can include a saw table defining a table surface; a saw cabinet coupled to the saw table; a damper coupled to the saw cabinet; a saw coupled to the damper and disposed within the saw cabinet; and a controller storing instructions in non-transitory memory that, when executed, can cause the controller to: advance the saw from a resting position to an intermediate position at a first rate; advance the saw from the intermediate position to a cutting position at a second rate; and retract the saw from the cutting position to the resting position.

In one aspect, a cold saw system can be an integrated system including a saw, a damper, an infeed table, an outfeed table, and a controller co-operating with each other. One or more cutting actions performed by the saw and the damper can be coordinated by the controller with one or more material handling actions performed by a push feeder on the infeed table and/or outfeed table. For example, the push feeder can advance along a length of the infeed table and position a stock piece accurately to prescribed lengths with repeatable tight tolerances, and the saw can make cuts at the prescribed lengths.

In one aspect, a system can include a saw table defining a saw table surface and having a coolant reservoir; a saw coupled to the saw table; a table defining a table surface and having a plurality of post brackets, wherein the table surface can be coplanar with the saw table surface; a guttering assembly coupled to the table, wherein the guttering assembly can include a trough support coupled to a corresponding one of the post brackets and a trough piece coupled to the trough support. The trough piece can form a trough configured to collect coolant draining off the table surface and channel the coolant to the coolant reservoir.

In one aspect, a guttering assembly for a cold saw system can include a plurality of trough support brackets, a plurality of trough segments, and a plurality of back trough brackets. Each trough support bracket can be configured to be coupled to a corresponding post bracket of a table of the cold saw system. Each trough segment can be configured to extend underneath a table surface of the table between adjacent ones of the trough support brackets. Each back trough bracket can be configured to be coupled to a corresponding post bracket.

In one aspect, a method of assembling a cold saw system can include coupling a plurality of trough support brackets to corresponding ones of a plurality of post brackets of a table of the cold saw system, coupling a plurality of trough segments to the plurality of trough support brackets to form a trough, and fluidly coupling the trough to a coolant reservoir of the cold saw system.

### BRIEF DESCRIPTION OF THE DRAWINGS

FIG. 1A is a perspective view of a cold saw system, according to an example.

FIG. 1B is a second perspective view of a portion of the cold saw system of FIG. 1A.

FIG. 2 is a side view of a saw of a cold saw system, according to an example.

FIG. 3A is a view of a damper of the system of FIGS. 1A-1B.

FIG. 3B is a view of a portion of the damper of FIG. 3A.

FIG. 3C is a view of a portion of the damper of FIGS. 3A-3B.

FIG. 4 is a perspective view of a clamp for a cold saw system, according to an example.

FIG. 5 is a front view of a pneumatic control panel for a cold saw system, according to an example.

FIG. 6 is a perspective view of a portion of an infeed table of the system of FIG. 1A.

FIG. 7A is a side view of an anchor portion of an emergency pull line assembly for a cold saw system, according to an example.

FIG. 7B is a side view of a switch portion of the emergency pull line assembly of FIG. 7A.

FIG. 8 is a perspective view of a controller for a cold saw system, according to an example.

FIG. 9 is a front view of a first user interface of the controller of FIG. 8.

FIG. 10 is a home screen displayed on a display of the first user interface of FIG. 9.

FIG. 11 is a manual movement screen displayed on a display of the first user interface of FIG. 9.

FIGS. 12A-12B are incremental movement screens displayed on a display of the first user interface of FIG. 9.

FIGS. 13A-13D are preset programming screens displayed on a display of the first user interface of FIG. 9.

FIGS. 14A-14C are preset implementation screens displayed on a display of the first user interface of FIG. 9.

FIGS. 15A-15B are calibration screens displayed on a display of the first user interface of FIG. 9.

FIGS. 16A-16M are parts list programming screens displayed on a display of the first user interface of FIG. 9.

FIG. 17 is a saw delay screen displayed on a display of the first user interface of FIG. 9.

FIG. 18 is a clamp delay screen displayed on a display of the first user interface of FIG. 9.

FIG. 19 is a cycle time out screen displayed on a display of the first user interface of FIG. 9.

FIG. 20 is a side view of the cold saw system of FIG. 1 including a guttering assembly, according to an example.

FIG. 21 is a perspective view of a first portion of the guttering assembly of FIG. 20.

FIG. 22 is a perspective view of a second portion of the guttering assembly of FIG. 20.

FIG. 23 is a perspective view of a third portion of the guttering assembly of FIG. 20.

FIG. 24 is a perspective view of a back portion of the guttering assembly of FIG. 20.

FIG. 25 is a perspective view of a back portion of the guttering assembly of FIG. 20.

FIG. 26 is a perspective view of the guttering assembly of FIG. 20.

FIG. 27 is a perspective view of the first portion of the guttering assembly of FIG. 20.

FIG. 28 is a perspective view of the first portion of the guttering assembly of FIG. 20.

FIG. 29 is a side view of the first portion of the guttering assembly of FIG. 20.

FIG. 30 is a perspective view of a seam of the guttering assembly of FIG. 20.

FIG. 31 is a side view of the infeed table and the guttering assembly of FIG. 20 during a first stage of a guttering assembly installation process.

FIG. 32 is a side view of the infeed table and the guttering assembly of FIG. 20 during a first stage of a guttering assembly installation process.

FIG. 33 is a perspective view of a cold saw system including a guttering assembly, according to another example.

FIG. 34 is a perspective view of the guttering assembly of FIG. 33.

FIG. 35 is a perspective view of the guttering assembly of FIG. 33.

FIG. 36 is a side view of the guttering assembly of FIG. 33.

FIG. 37 is a perspective view of a guttering assembly for a cold saw system, according to another example.

FIG. 38 is a side view of the guttering assembly of FIG. 37.

FIG. 39 is a perspective view of the guttering assembly of FIG. 37.

FIG. 40 is a perspective view of a guttering assembly for a cold saw system, according to another example.

FIG. 41 is a side view of the guttering assembly of FIG. 40.

FIG. 42 is a perspective view of a guttering assembly for a cold saw system, according to another example.

FIG. 43 is a perspective view of the guttering assembly of FIG. 42.

FIG. 44 is a side view of the guttering assembly of FIG. 42.

### DETAILED DESCRIPTION

### Explanation of Terms

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed embodiments are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

As used in this disclosure and in the claims, the singular forms “a,” “an,” and “the” include the plural forms unless the context clearly dictates otherwise. Additionally, the term “includes” means “comprises.” Further, the terms “coupled” and “associated” do not exclude the presence of intermediate elements between the coupled or associated items absent specific contrary language.

Although there are alternatives for various components, dimensions, parameters, operating conditions, etc., set forth herein, that does not mean that those alternatives are necessarily equivalent and/or perform equally well. Nor does it mean that the alternatives are listed in a preferred order unless stated otherwise.

### Embodiments of the Disclosed Technology

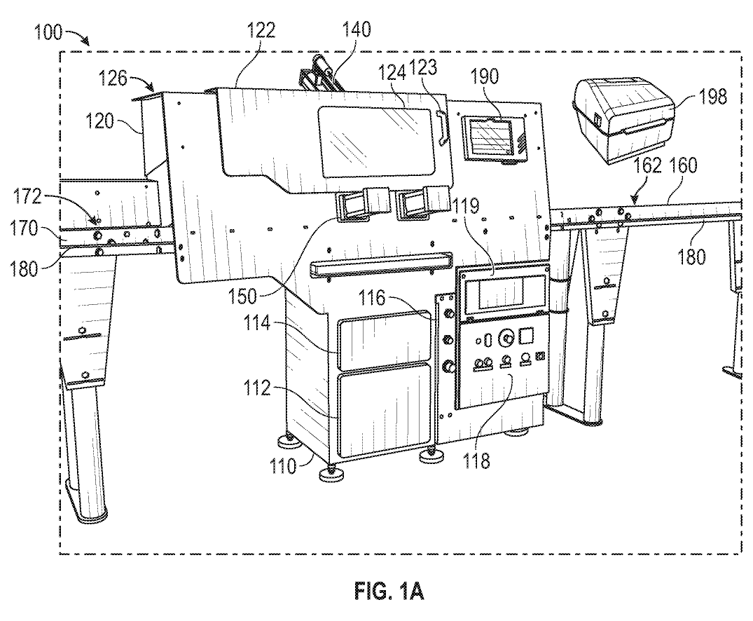

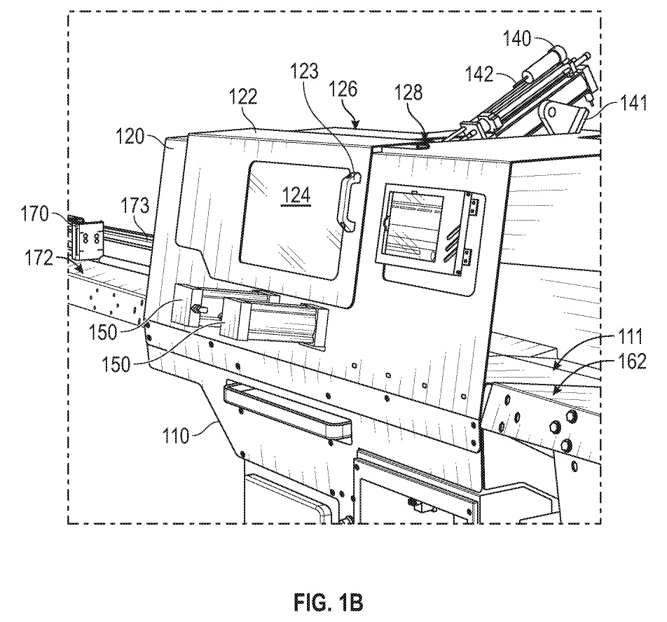

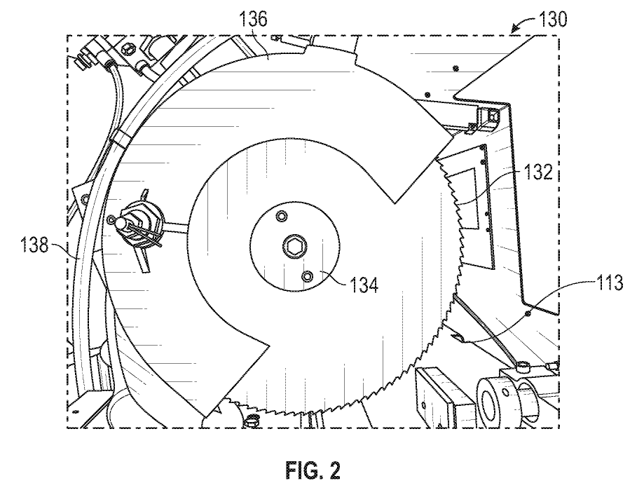

FIGS. 1A-1B are perspective views of a cold saw system 100 for cutting a workpiece (not shown), according to an example. The illustrated cold saw system 100 is configured to cut workpieces made of ferrous metals (for example, carbon steel, stainless steel, steel alloys, an wrought iron). However, in some examples, the cold saw system 100 can be configured to cut workpieces made of non-ferrous metallic materials (for example, aluminum, copper, nickel, zinc, etc.). The cold saw system 100 includes a saw table 110, a saw cabinet 120, a saw 130 (best shown in FIG. 2), a damper 140, clamps 150, an infeed table 160, and an outfeed table 170, an emergency pull line assembly 180, and a controller 190.

Although the foregoing description illustrates implementations in which a circular saw is used to perform the cutting operation, it should be understood that other types of cutting devices can be employed in place of or in addition to a circular saw. The principles, structures, and features described herein can be implemented with any suitable cutting device capable of performing comparable cutting operations, including but not limited to bandsaws, abrasive saws, reciprocating saws, or other mechanical cutting tools. Accordingly, references to a circular saw are intended to illustrate one exemplary cutting mechanism and should not be construed as limiting the scope of the claimed invention to any particular type of saw or cutting technology. As such, unless the context indicates otherwise, references to a circular saw herein are intended to encompass alternative cutting mechanisms capable of performing comparable cutting actions.

The saw table 110 is a structure that forms a flat table surface 111 (best shown in FIG. 1B) on which the workpiece rests and is fed into the circular saw 130. The saw table 110 can serve as a housing for certain components of the cold saw system 100. For example, as shown, the saw table 110 can include a coolant reservoir cabinet 112 for housing a coolant reservoir. The coolant reservoir can hold coolant that is sprayed onto the workpiece during cutting to reduce heat buildup in the workpiece. As shown, the saw table 110 further includes a strainer cabinet 114 for housing a coolant strainer. The coolant strainer can filter out swarf (in other words, debris) from coolant that was sprayed on the workpiece and circular saw, thereby allowing this coolant to be collected in the coolant reservoir and reused.

Referring now to FIG. 2, the saw table 110 includes one or more slots 113 in the table surface 111. The slots 113 can be fluidly coupled to the coolant strainer in the strainer cabinet 114 and can be configured to drain coolant collecting on the table surface 111 into the coolant strainer. In some examples, the table surface 111 can be tilted, curved, or otherwise configured in a way that directs coolant collecting on the table surface 111 toward the slots 113.

In some implementations, coolant collecting on the table surface can include not only coolant that drips directly onto the table surface, but also coolant that drains through gaps, openings, or spaces formed in the table surface, including gaps that may exist to accommodate rollers, material-support features, or other structures that facilitate movement of workpieces. Such gaps may occur anywhere within the cutting envelope where material is expected to travel, whether being manually moved, automatically positioned, or push-fed along the table. Accordingly, the guttering assembly is configured to capture coolant draining from any portion of the table surface—including through-table gaps—and direct the collected coolant toward the coolant reservoir.

Now referring back to FIGS. 1A-1B, the saw table 110 can include controls for operating and/or controlling the cold saw system 100. For example, the saw table 110 can include a pneumatic control panel 116 for controlling pneumatic components of the saw table system 100. For example, the pneumatic control panel 116 can include controls (for example, knobs) for adjusting the speed at which the clamps engage the workpiece and/or the force applied to the workpiece by the clamps. As further shown, the saw table 110 includes a power control panel 118 for adjusting the supply of electrical power to the cold saw system 100. For example, the power control panel 118 can include a power switch, an emergency stop switch. The power control panel 118 can further include indicator lights that provide information on the operational status of the cold saw system 100 and its constituent subsystems. As further shown, the saw table 110 includes an I/O panel 119 that serves as a communications hub for the electromechanical components of the cold saw system 100.

The saw cabinet 120 is an enclosure mounted on the saw table 110. The saw cabinet 120 is configured to fully enclose the circular saw 130 to help prevent the user of the cold saw system 100 from contacting the circular saw 130 during operation. The saw cabinet 120 is also configured to help contain debris (for example, dust or chips), coolant, and noise generated during operation therein, thereby further protecting the user. As shown, the cabinet 120 includes a guard door 122 that, when opened, allows access to the table surface 111 for adjusting the workpiece, maintenance, and cleaning. The guard door 122 includes a handle 123 and a window 124 for viewing the table surface 111 and the workpiece disposed thereon. As further shown, the saw cabinet 120 includes a top surface 126 defining a top portion of the enclosure and an aperture 128 in the top surface 126.

In some examples, the saw cabinet 120 can include a mechanical interlock switch. The mechanical interlock switch can be configured to ensure the safety of a user of the cold saw system 100 by preventing the operation (for example, the rotational and/or positional movement) of the circular saw 130 when the guard door 122 is opened. For example, the mechanical interlock switch can be electrically coupled to the circular saw 130 (for example, via the controller 190 and/or another circuit of the cold saw system 100) such that the circular saw 130 cannot change position when the guard door 122 is opened. Furthermore, the mechanical interlock switch can be electrically coupled to the circular saw 130 in a way that prevents the circular saw 130 from forming a cut, e.g., in a workpiece, when the guard door 122 is opened. Thus, the mechanical interlock switch prevents the circular saw 130 and/or other components of the cold saw system 100 from being activated, used, cycled, moved, etc. when the guard door 122 is not in a position to fully protect the user.

Now referring to FIG. 2, the cold saw system 100 includes the circular saw 130. The circular saw 130 is configured to form a cut in the workpiece. As shown, the circular saw 130 includes a toothed, circular saw blade 132. The saw blade 132 is configured to cut ferrous materials, including but not limited to iron, steel, and steel alloys. In some examples, the saw blade 132 can be made at least partially from high strength steel (HSS) and/or carbide (for example, the blade 132 can include carbide-tipped teeth). In some examples, the saw blade 132 can have a bi-metal construction configured for cutting ferrous materials. As shown, the circular saw 130 further includes a collar 134 for securing the circular saw blade 132 to a shaft. The shaft in turn is coupled to a motor (for example, an electric motor) that generates torque for rotating the circular saw blade 132. The motor can be configured to receive signals via the I/O panel 119. In some examples, the collar 134 can provide additional support for the saw blade 132 to help reduce blade vibration and wobble. The circular saw 130 can further include a blade guard 136 disposed over a portion of the saw blade 132, thereby preventing the saw blade 132 from contacting the user or other components of the cold saw system 100 during operation.

In some examples, the circular saw 130 is moveable between a resting position and a cutting position. In the resting position (best shown in FIG. 2), the circular saw 130 is retracted such that the saw blade 132 cannot engage the workpiece disposed on the table surface 111. In the cutting position (best shown in FIG. 1B), the circular saw 130 is advanced such that the saw blade 132 can contact and/or cut the workpiece disposed on the table surface 111. The cold saw system 100 can include an actuator, including but not limited to any one of a linear actuator, a cam actuator, a screw actuator, and a hydraulic actuator, for moving the circular saw 130 between the resting position and the cutting position. The actuator can be configured to receive signals via the I/O panel 119.

Now referring to FIG. 2, the cold saw system 100 can further include a coolant line 138 for transferring coolant. During operation of the cold saw system 100, coolant can be pumped from the coolant reservoir stored in the coolant reservoir cabinet 112 and out through the coolant line 138 to spray coolant onto the saw blade 132 and/or the workpiece. In some examples, the cold saw system 100 can include a pump fluidly connected to the coolant reservoir and the coolant line 138 for pumping the coolant. In some examples, the cold saw system 100 can include a nozzle for directing the spray of coolant. In some examples, coolant can help reduce friction between the saw blade 132 and the cutting surface of the workpiece, thereby reducing heat buildup in the workpiece.

Now referring back to FIGS. 1A-1B, the cold saw system 100 includes the damper 140, which is configured to regulate the movement of the circular saw 130 relative to the workpiece. As shown, the damper 140 is mounted to the top surface 126 of the saw cabinet 120 using a mount 141, and a portion of the damper 140 extends through the aperture 128 in the top surface 126 and into the enclosure formed by the saw cabinet 120. The circular saw 130, which is disposed within the saw cabinet 120, is coupled to an end portion of the damper 140.

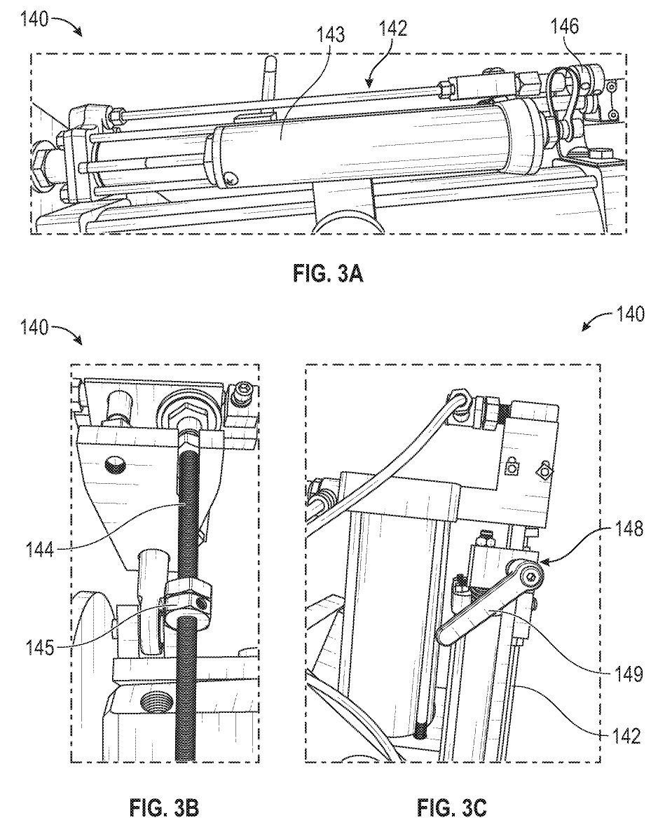

Now referring to FIGS. 3A-3C, the illustrated damper 140 includes a return tube 142. The return tube 142 can include an enclosed reservoir 143 filled at least partially with a fluid (for example, compressed air, oil, etc.), wherein the reservoir 143 is coupled to the mount 141. The return tube 142 can include a rod 144 extending from an end of the reservoir 143. The circular saw 130 can be coupled to the rod 144 such that as the circular saw 130 moves relative to the reservoir 143 and the mount 141 (for example, as the circular saw 130 moves toward or away from the cutting position), the rod 144 forces fluid through an orifice within the return tube 142 to resist the relative movement of the rod 144 (and the corresponding movement of the circular saw 130).

In some examples, the damper 140 is configured not to slow or dampen the movement of the circular saw 130 until the circular saw 130 reaches an intermediate damper activation position disposed between the resting position and cutting position. In such examples, a hard stop bracket can be fixedly coupled to the circular saw 130. The hard stop bracket can be coupled to the rod 144; for example, the rod 144 can seated in a slot or hole in the hard stop bracket.

Now referring to FIG. 3B, the rod 144 can be threaded and one or more nuts 145, which can be screwed onto the rod 144. As the circular saw 130 is advanced from the resting position to the damper activation position, the nuts 145 do not engage the hard stop bracket, thereby allowing the rod 144 to move freely relative to the hard stop bracket (and thus allow the circular saw 130 to move freely relative to the damper 140). Thus, as the circular saw 130 is advanced from the resting position to the damper activation position, the damper 140 does not slow the movement of the circular saw 130. However when the circular saw 130 reaches the damper activation position, the nuts 145 contact and engage the hard stop bracket attached to the circular saw 130 (forcing the circular saw 130, the hard stop bracket, the rod 144, and the nuts 145 to move in unison from the damper activation position to the cutting position). Thus, as the circular saw 130 advances past the damper activation position and to the cutting position, the rod 144 is pushed into the reservoir 143 and forces fluid through a narrow orifice within the reservoir 143, thereby creating resistance to the movement of the circular saw 130 moving in unison with the rod 144. In some examples, the distance between the damper activation position and the cutting position can be approximately one eighth of an inch (1/8”). However, the damper activation position can be increased or decreased by moving the nuts 145 relative to the threaded rod 144.

By only dampening the movement of the circular saw 130 after the circular saw 130 passes the damper activation position, the damper 140 allows the circular saw 130 to be quickly advanced between the resting position and damper activation position to reduce overall cycle time while also ensuring that the down feed rate of the circular saw 130 is sufficiently slow, for example, to reduce heat buildup within the workpiece, to reduce the amount of noise made while cutting the workpiece, and/or to make a higher-quality cut. As used herein, the term “down feed rate” refers to the rate at which the circular saw 130 advances from the damper activation position to the cutting position.

Now referring to FIG. 3A, the damper 140 can include a down feed rate adjustment knob 146 for adjusting the down feed rate of the circular saw 130. In some examples, the down feed rate adjustment knob 146 can be coupled to an actuator (for example, a rotary servomotor or rotary actuator) to allow for the automatic adjustment of the down feed rate. The actuator can be configured to receive commands via the I/O panel 119.

Now referring to FIG. 3C, the damper 140 can include a cutting envelope adjuster 148 for adjusting a cutting envelope of the circular saw 130. As used herein, the term “cutting envelope” refers to the maximum dimension within which the circular saw 130 can cut. The cutting envelope adjuster 148 can include a worm screw (or any other type of linear actuator) coupled to the reservoir 143 of the return tube 142 and a lever 149 coupled to the worm screw. Rotating the lever 149 allows the cutting envelope adjuster 148 to be moved closer to or away from a tool at extension sensor. In some examples, reducing the size of the cutting envelope can help prevent the cold saw system 100 from cutting past the workpiece and thus reduce the amount of time wasted by cutting past the workpiece. In some examples, moving the cutting envelope adjuster 148 closer to the tool at extension sensor can decrease the cutting envelope while moving the cutting envelope adjuster 148 further from the tool at extension sensor can increase the cutting envelope. In some examples, the lever 149 can be replaced with an actuator to allow for the automatic adjustment of the cutting envelope. The actuator can be configured to receive commands via the I/O panel 119.

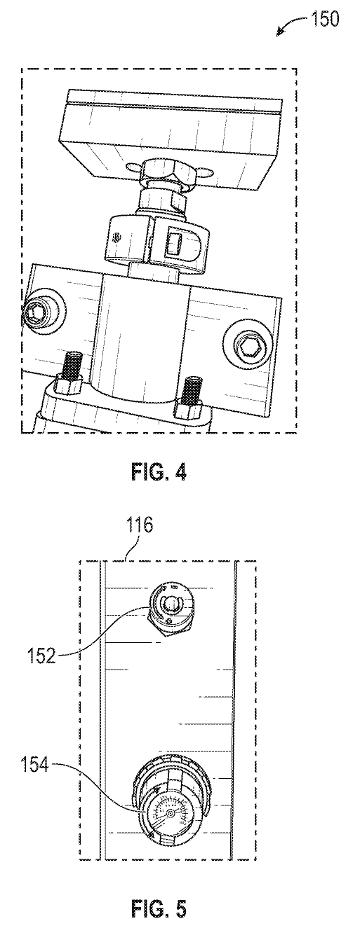

Now referring to FIG. 4, the cold saw system 100 includes at least one clamp 150 configured to releasably engage the workpiece disposed on the table surface 111 of the saw table 110. In some examples, the clamps 150 can be pneumatic clamps that receive compressed air via the pneumatic control panel 116. For example, the pneumatic control panel 116 can be coupled to one or more solenoid valves, which can be fluidly connected to an air supply (for example, an air compressor). The solenoid valves can be fluidly connected to the clamps 150 and can activate or deactivate the clamps 150 by selectively supplying the clamps 150 with pressurized air. The solenoid valves can be configured to receive signals from the I/O panel 119.

Now referring to FIG. 5, the pneumatic control panel 116 can include a clamp speed knob 152 to adjust the speed at which the clamps 150 engage with workpiece and a clamp pressure knob 154 to adjust the force by which the clamps 150 engage the workpiece. In some examples, these knobs 152, 154 can be coupled to actuators to allow for the automatic adjustment of clamp speed and clamp pressure. The actuators can be configured to receive signals from the I/O panel 119.

Referring back to FIGS. 1A-1B, the cold saw system 100 includes two clamps 150 arranged on opposite sides of the circular saw 130. However, the cold saw system 100 can include any number of clamps 150 arranged in any configuration.

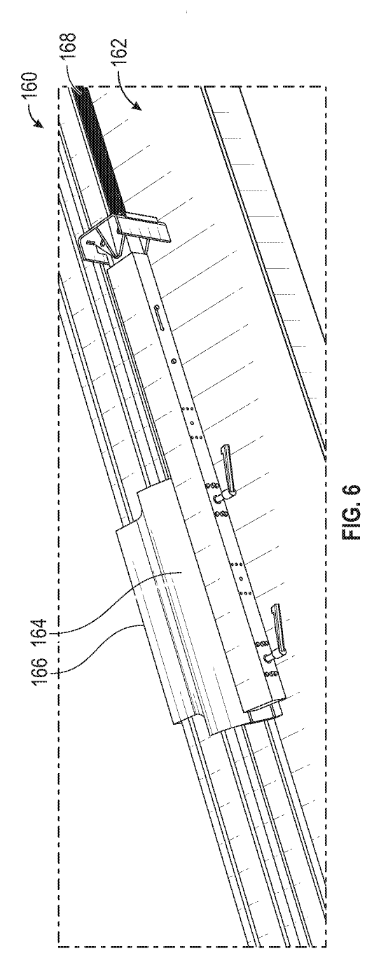

Referring now to FIG. 6, the infeed table 160 can be configured to automatically advance a workpiece toward the cutting saw 130. As shown, the infeed table 160 can include an infeed table surface 162 and a push feeder comprising a push feeder carriage 164 resting on the infeed table surface 162. The infeed table surface 162 can be coplanar with the table surface 111 of the saw table 110. The push feeder carriage 164 can include a housing 166 and a motor (not shown) disposed within the housing 166. The motor can be configured to propel the push feeder carriage 164 along a length of the infeed table 160. The push feeder is integrated into the cold saw system 100 such that the motor can be controlled based on user input and/or based on a signal from the controller 190. When a workpiece is placed on the infeed table surface 162, the workpiece can be engaged by the push feeder carriage 164 and pushed toward the circular saw 130. In some examples, the infeed table 160 can include a backfence extending from the infeed table surface 162. The backfence of the infeed table 160 can have a similar structure as the backfence 173 of the outfeed table 170 shown in FIG. 1B.

Referring back to FIGS. 1A-1B, the outfeed table 170 can be configured to automatically advance a cut workpiece away from the cutting saw 130. The outfeed table 170 can include an outfeed table surface 172 that is coplanar with the table surface 111 of the saw table 110 and a pull feeder. In some examples, the pull feeder of the outfeed table 170 can include a carriage similar to the push feeder carriage 164 of the infeed table 160. The carriage of the pull feeder can be coupled to the workpiece and configured to pull the workpiece along a length of the outfeed table surface 172. The carriage of the pull feeder can include a motor (similar to the motor of the push feeder carriage 164) to move it along the outfeed table surface 172, and the motor can similarly be controlled by the controller 190. Thus, similar to the push feeder, the pull feeder can be integrated into the cold saw system 100.

Referring back to FIG. 1B, the outfeed table 170 can further include a backfence 173. The backfence 173 can be a structure extending from the outfeed table surface 172. The backfence 173 can be used to align the workpiece as the workpiece travels along a length of the outfeed table surface 172. In some examples, the backfence 173 can be used as a rail along which the carriage of the outfeed table 170 can slide. Still referring to FIG. 1B, in some examples, at least one of the infeed table surface 162 and the outfeed table surface 172 can be tilted at an angle relative to the table surface 111 of the saw table 110 and/or a ground surface upon which the cold saw system rests. For example, as shown in FIG. 1B, the infeed table surface 162 can be tilted at an angle relative to the table surface 111 of the saw table 110 such that a lateral edge of the infeed table surface 162 closer to the backfence is vertically lower than a lateral edge of the infeed table surface 162 further away from the backfence. In some examples, tilting the infeed table surface 162 and/or the outfeed table surface 172 in this manner can help ensure workpieces with rounded shapes stay flush against the backfence (for example, backfence 173) as the workpieces are pushed along the infeed table 160 towards the circular saw 130 and/or pulled along the outfeed table 170 away from the circular saw 130. In some examples, each one of the table surface 111, the infeed table surface 162, and the outfeed table surface 172 can be tilted at an angle (for example, the same angle) relative to the ground surface.

Referring now to FIGS. 1A-1B, the cold saw system 100 can include an emergency pull line assembly 180 configured to stop the cold saw system 100 in case of an emergency. The emergency pull line assembly 180 can be configured to protect the user in areas where material is being loaded or unloaded. The emergency pull line assembly 180 can include a pull line 182 extending along a length of at least one of the infeed table 160 and the outfeed table 170. In some examples, the pull line 182 can extend along the entire length of at least one of the infeed table 160 and the outfeed table 170. As shown, the cold saw system 100 can include an emergency pull line assembly 180 with a first pull line 182 extending along the entire length of the infeed table 160 and a second emergency pull line assembly 180 with a second pull line 182 extending along the entire length of the outfeed table 170. When either pull line 182 is pulled by a user of the cold saw system 100, the cold saw system 100 automatically halts the motor coupled to the saw blade 132 and stops the movement of the damper 140, thereby stopping the rotational and positional movement of the circular saw 130 to ensure the safe cessation of operation of the cold saw system 100.

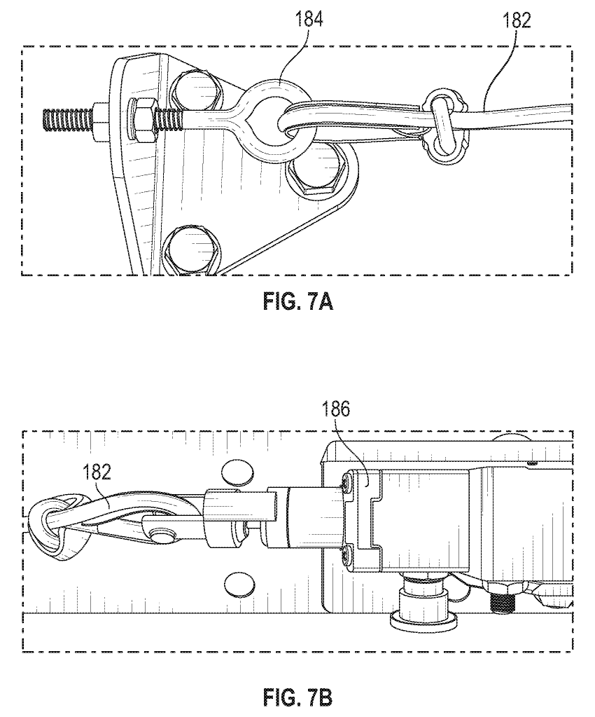

Now referring to FIGS. 7A-7B, each emergency pull line assembly 180 includes the pull line 182 anchored at a first end to an emergency pull line anchor 184 and anchored at a second end to an emergency pull line switch 186. In some examples, each emergency pull line switch 186 can be coupled to the I/O panel 119. In some examples, the emergency pull line switches 186 can be coupled to a circuit separate from the I/O panel 119. For example, each emergency pull line switch 186 can be coupled to a corresponding independent circuit, and each independent circuit can be configured to stop the movement of the circular saw 130. In some examples, coupling each emergency pull line switch 186 to its own independent circuit can beneficially increase the redundancy of the safety features of the cold saw system 100 in case one of the emergency pull line switches 186 and/or its corresponding independent circuit fails.

Now referring back to FIGS. 1A-1B, the cold saw system 100 includes a controller 190 configured to send commands to the electromechanical components of the cold saw system 100. As shown, the controller 190 is coupled to the saw cabinet 120. However, the controller 190 can be disposed on any portion of the cold saw system 100.

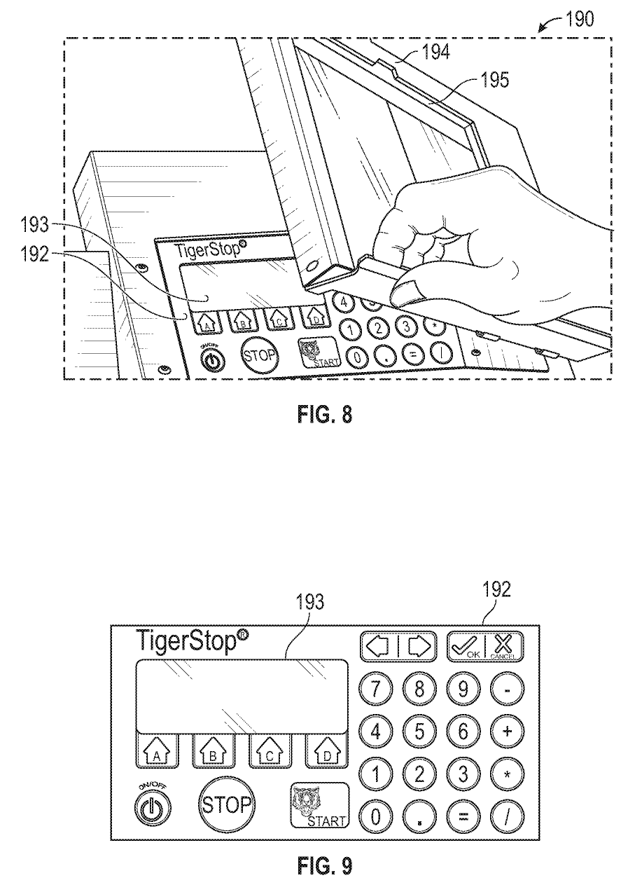

Now referring to FIGS. 8-9, the controller 190 can include a first user interface 192 and a second user interface 194. As shown, the first user interface 192 includes a non-touchscreen display 193 and the second user interface 194 includes a touchscreen display 195. In some examples, the second user interface 194 can be an optional upgrade for the cold saw system 100. However, the controller 190 can include any number of touchscreen interfaces and non-touchscreen interfaces in any combination.

As further shown, the second user interface 194 can be hingedly coupled to the first user interface 192, and can be moved between a closed position and an open position relative to the first user interface 192. When the second user interface 194 is in the closed position, the second user interface 194 can cover the first user interface 192. The first user interface 192 and the second user interface 194 can face the same direction (for example, toward the user) when the second user interface 194 is in the closed position. When the second user interface 194 is in the open position, the user can access the first user interface 192. In this way, the first user interface 192 and the second user interface 194 can both be accessible to the user without increasing the footprint of the controller 190 on the saw cabinet 120.

The controller 190 can be any computing unit and/or device that includes a processor and a memory. In some examples, the processor can be an integrated circuit, an application specific integrated circuit (ASIC), a digital signal processor (DSP), a field programmable gate array (FPGA), a programmable logic controller (PLC), and/or any combination thereof designed to perform the functions described herein. In some examples, the memory can be a non-transitory memory configured to store instructions that are executable by the processor. In some examples, the controller 190 can comprises a plurality of computing units. For example, the first user interface 192 and the second user interface 194 can be separate computing devices. In some examples, the functionality of the controller 190 can be divided among the plurality of computing units (for example, divided between the first user interface 192 and the second user interface 194). In some examples, each of the first user interface 192 and the second user interface 194 can possess the entire functionality of the controller 190; in other words, the first and second user interfaces 192, 194 can be redundant. In some examples, the redundant second user interface 194 can be an optional upgrade that is added to at least partially replace the first user interface 192 to add touch screen functionality to the cold saw system 100. In some examples, the plurality of computing units can communicate with each other over a wired or wireless connection.

The controller 190 can send signals to the electromechanical components of the cold saw system 100 connected to the I/O panel 119, thereby allowing for automatic operation of the cold saw system 100. For example, memory of the controller 190 can store instructions that, when executed, cause the cold saw system 100 to perform a cutting action that forms a cut in the workpiece. The cutting action can include moving the workpiece into place via a positioner (for example, the push feeder carriage 164 of the infeed table 160 and/or the carriage of the outfeed table 170), engaging the workpiece with the clamps 150, activating the coolant pump to spray coolant onto the workpiece and/or the saw blade 132, activating the circular saw 130 to begin rotation of the saw blade 132, advancing the circular saw 130 from the resting position to the cutting position, retracting the circular saw 130 from the cutting position to the resting position, deactivating the circular saw 130 to stop rotation of the saw blade 132, deactivating the coolant pump, and disengaging the clamps 150 from the workpiece.

In some examples, one or more sensors can be connected to the controller 190 (for example, via the I/O panel 119). For example, the cold saw system 100 can include a tool position sensor that detects the position of the circular saw 130. For example, the tool position sensor can detect whether the circular saw 130 is at rest in the resting position or at extension in the cutting position.

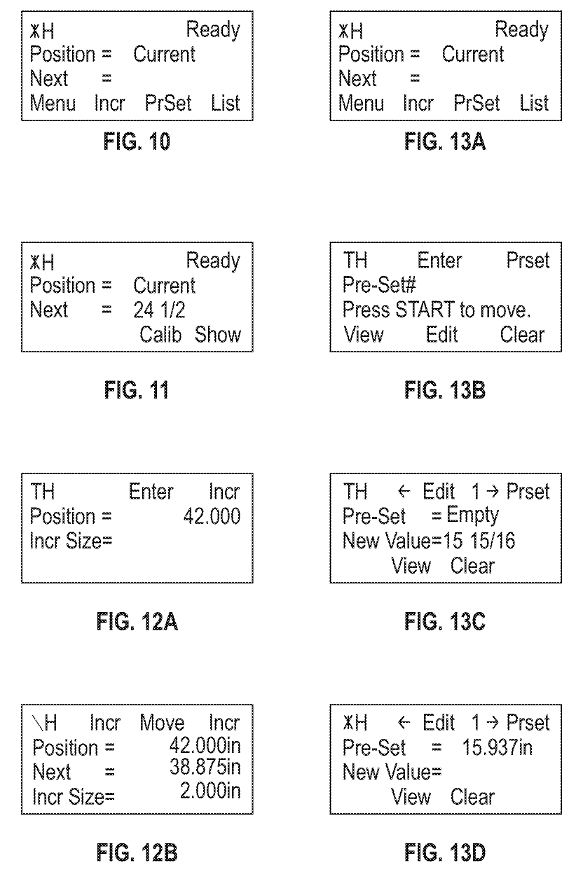

FIG. 10 is a ready screen displayed on the display 193 of the first user interface 192. The ready screen can be the initial screen or default screen shown on the display 193.

FIG. 11 is a manual movement screen displayed on the display 193 of the first user interface 192. The controller 190 can have a manual movement functionality to move a workpiece on the table surface 111 of the saw table 110. For example, the user can enter a manual movement length by which to move the workpiece on the table surface 111 of the saw table 110 relative to the circular saw 130. As shown the manual movement length can be entered as a fractional value (for example twenty four and one half inches would be entered as “24 ½”). However, in some examples, the manual movement length can be entered as a decimal value (for example “24.5”). Any length described herein, not just the manual movement length, can be entered into the controller 190 as either a fractional or decimal value. Upon receiving the length input by the user, the controller 190 can actuate the clamps 150, the push feeder carriage 164 of the infeed table 160, and/or the pull feeder of the outfeed table 170 to move the workpiece by the length.

FIGS. 12A-12B are incremental movement screens displayed on the display 193 of the first user interface 192. The controller can have an incremental movement functionality to repeatedly move the workplace by an increment length. As shown in FIG. 12A, the user can press an increment button (Incr) and enter the increment length, for example, 42.000 inches. As shown in FIG. 12B, each time the user presses a button, the workpiece is moved by the increment length. The incremental movement screen can display the current position, the next position, and the increment length.

FIGS. 13A-13D are preset programming screens displayed on the display 193 of the first user interface 192. The controller 190 can have a preset functionality that stores a preset length in the memory of the controller 190 and moves the workpiece by the preset length. FIGS. 13A-13D show how the user can add or update a preset length using the first user interface 192. For example, the user can press a preset key (PrSet) to access the preset feature (FIG. 13A). The user can then enter a preset number to program corresponding to the desired preset (FIG. 13B), enter a preset length for the desired preset as either a decimal or fraction value (FIG. 13C), and save the mapping of the preset length to the preset number in the controller’s memory (FIG. 13D).

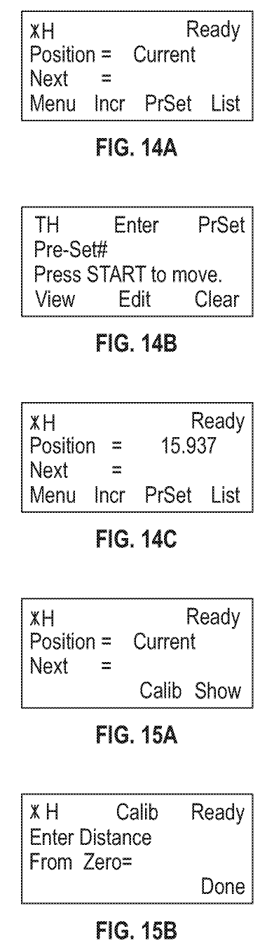

FIGS. 14A-14C are preset implementation screens displayed on the display 193 of the first user interface 192, showing how the user can use the preset functionality to move the workpiece by a preset length. The user can press the preset key (PrSet) (FIG. 14A), enter a preset program number to set a length (for example, the manual movement length or the increment length) equal to the desired preset length (FIG. 14B), and the workpiece will move to the preset length (FIG. 14C).

FIGS. 15A-15B are calibration screens displayed on the display 193 of the first user interface 192. The controller 190 can feature a quick calibration functionality that allows the cold saw system 100 to be quickly calibrated. During the quick calibration process, a workpiece is cut and measured by the user. The user can press a calibration key (Calib) (FIG. 15A) and then enter the measured length of the workpiece to calibrate the position of the stop to the measured length (FIG. 15B).

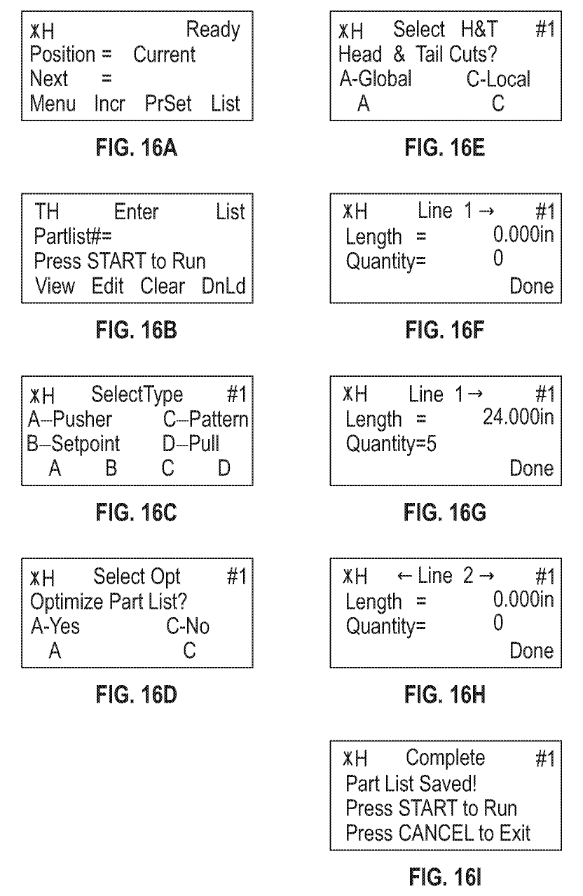

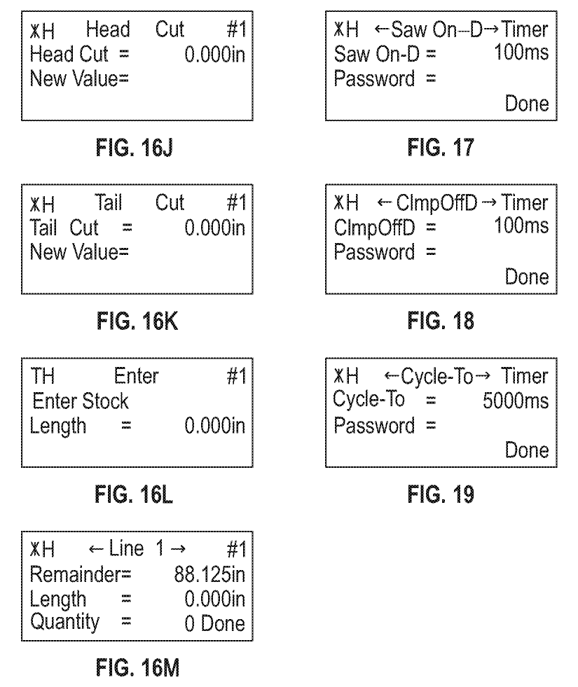

FIGS. 16A-16M are parts list screens displayed on the display 193 of the first user interface 192. The controller 190 can have a part list functionality, which allows the cold saw system 100 to automatically make one or more cuts in a desired workpiece to form a part. To program a part list, a user can press a list key (List) (FIG. 16A) and enter a list number to program (FIG. 16B). The user can then select which type of part list corresponds to the list number: a pusher list, a setpoint list, a pattern list, or a pull list (FIG. 16C).

The pusher list can be a list of instructions that command the cold saw system 100 to push a workpiece (for example, stock material) into the cold saw system 100, treating each length of the pusher list as an incremental movement.

The set point list can be a list of instructions that command the cold saw system to move a workpiece by an absolute value from a set point.

The pattern list can be a list of instructions for pushing stock material into the cold saw system 100 in a push-feed fashion to form parts out of the stock material. In some examples, the cold saw system 100 can be configured to repeat the pattern list a predetermined number of times. In some examples where the predetermined number of times is a user-defined number of times, the cold saw system 100 can prompt a user to enter the number of times the pattern list should be repeated, for example, via the first user interface 192 and/or the second user interface 194. In some examples, the cold saw system 100 can additionally or alternatively be configured to repeat the pattern list until it receives an instruction to stop. For example, the cold saw system 100 can be configured to repeat the pattern list until the controller 190 receives a command from the user via the first user interface 192 and/or the second user interface 194.

The pull list can be a list of instructions that pull stock material out of the cold saw system 100 in a pull-feed fashion. In some examples, the cold saw system 100 can be configured to repeat the pull list a predetermined number of times. In some examples, the predetermined number of times can be the user-defined number of times entered by the user via the first user interface 192 and/or the second user interface 194. In some examples, the cold saw system 100 can additionally or alternatively be configured to repeat the pull list until it receives an instruction to stop, for example, an instruction entered by the user via the first user interface 192 and/or the second user interface 194.

To program a pusher list or set point list, the user can then select whether the part list should be optimized for maximum material yield (FIG. 16D). The user can then select whether to use a global head and tail cut setting stored in the memory of the controller 190 or a local head and tail cut setting entered by the user for only the current part list (FIG. 16E). The user can then enter a desired length of the part (FIG. 16F) and the number of parts to process at the desired length (FIG. 16G). The user can enter additional lengths of additional parts to process (FIG. 16H) and then save the part list (FIG. 16I).

To program a pattern list or pull list, instead of programming the controller 190 as shown in FIGS. 16D-16H, the user instead enters a head cut value (FIG. 16J), a tail cut value (FIG. 16K), a stock length (FIG. 16L), and a length of the part to process (FIG. 16M). The user can enter subsequent parts to the pattern or pull list in the same screen (FIG. 16M) and then save the part list (FIG. 16I). In some examples, the controller 190 can restrict the user to entering part lengths and quantities that are less than or equal to a stock length of the material being fed into the cold saw system 100, minus a head cut and a tail cut. This can beneficially allow the controller 190 to restrict the user from attempting to cut too many parts from the material.

FIG. 17 is a saw on delay screen displayed on the display 193 of the first user interface 192. The controller 190 can have a saw on delay functionality that implements a time delay between the time the clamp 150 is activated and the time the circular saw 130 is activated and/or begins advancing from the resting position. In some examples, the saw delay can be approximately 100 milliseconds. In some examples, the saw on delay can beneficially ensure that the workpiece is clamped before the circular saw 130 is activated.

FIG. 18 is a clamp delay screen displayed on the display 193 of the first user interface 192. The controller 190 can have a clamp delay functionality that implements a time delay between the time a sensor (for example, a tool at rest sensor) detects that the circular saw 130 has returned to the resting position and the time that the clamp 150 disengages the workpiece. In some examples, the clamp off delay can be approximately 100 milliseconds. In some examples, a clamp delay can beneficially ensure that the circular saw 130 has fully disengaged the workpiece before the clamp 150 is released.

FIG. 19 is a cycle time out screen displayed on the display 193 of the first user interface 192. The controller 190 can have a cycle time out functionality to set a maximum cycle time for a cutting action. In some examples, the cycle time out can be approximately 5000 milliseconds. In some examples, the cycle time out functionality can beneficially ensure that the cycle time can be adjusted to allow for the cutting of workpieces of different thicknesses.

Now referring back to FIG. 1A, the cold saw system 100 can include a label printer 198. The label printer 198 can be configured to print out labels to affix to cut workpieces. In some examples, the label printer 198 can print a label for each cut workpiece. The label printer 198 can be configured to receive instructions to print labels from the controller 190 via the I/O panel 119.

One advantage of the disclosed cold saw system 100 over the prior art is that the cold saw system 100 is an integrated system including the circular saw 130, the damper 140, the infeed table 160, and the outfeed table 170 co-operating with each other. Since these components can all be centrally controlled, e.g., by the controller 190, the cutting actions performed by the circular saw 130 and the damper 140 can be coordinated with the material handling actions performed by the positioner on the infeed table and outfeed tables.

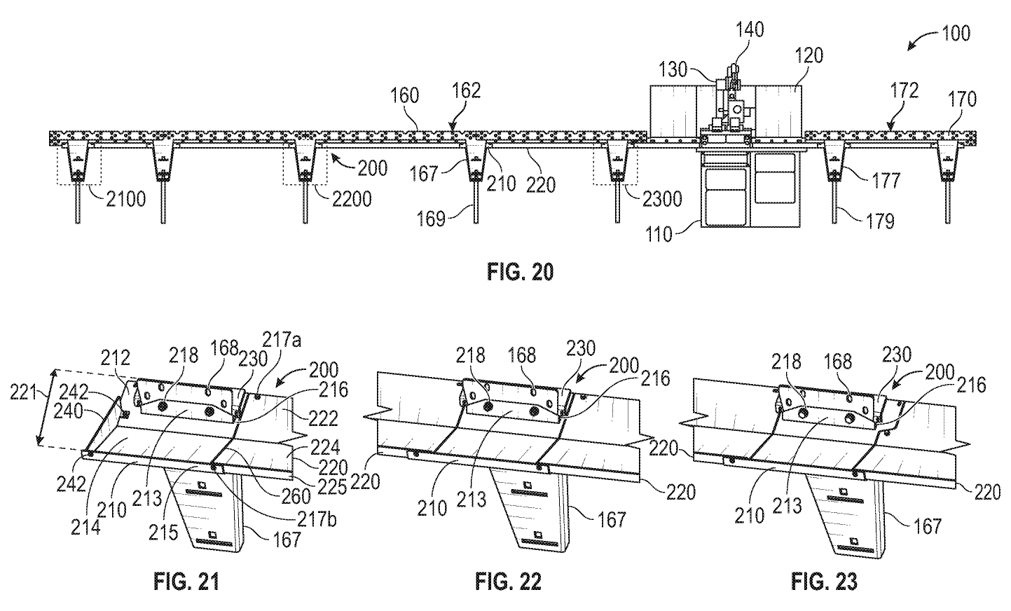

FIG. 20 is a side view of the cold saw system 100, according to an example. As shown, some examples of the cold saw system 100 can include a guttering assembly 200 (which is also referred to herein as a “guttering system,” a “gutter assembly,” and/or a “gutter system”) coupled to the saw table 110 and at least one of the infeed table 160 and the outfeed table 170. The guttering assembly 100 is configured to collect coolant that drains off the infeed table surface 162 and/or the outfeed table surface 172 and is further configured to channel the collected coolant into the coolant reservoir of the saw table 110 or to a secondary reservoir in the event that it is not desirable to return the coolant to the coolant reservoir. Accordingly, the guttering assembly 200 can beneficially reduce coolant spillage and, in some embodiments, can beneficially help reclaim coolant for reuse.

Although generally described below with coolant being reclaimed for reuse, in some implementations, the system can further include a secondary coolant reservoir and/or auxiliary filtration unit configured to receive coolant collected by the guttering assembly in situations where the guttering assembly does not return coolant directly to the main coolant reservoir of the saw table. In such implementations, the guttering assembly can discharge coolant into a secondary reservoir positioned beneath or adjacent to the table. The secondary reservoir can include its own filter, strainer, or debris-capture element to remove swarf or contaminants before the coolant is manually or automatically transferred back to the primary coolant reservoir. In this way, coolant recovery can still be achieved even when the guttering assembly is not fluidly coupled to the main reservoir, thereby reducing coolant loss and maintaining system efficiency. Secondary coolant reservoir can be located adjacent to the coolant reservoir (e.g., the description below is the same with only the discharge location varying). Alternatively, the secondary coolant reservoir can be located at any suitable location connected to a coolant discharge line.

As shown in FIG. 20, the infeed table 160 can include at least one infeed post bracket 167 (which is also referred to herein as an “infeed leg bracket”) and at least one post 169 (which is also referred to herein as a “leg”) configured to support the infeed table surface 162. As shown in FIGS. 21-23, the infeed post bracket 167 can include apertures 168 configured to receive fasteners that couple the infeed post bracket 167 to the rest of the infeed table 160.

Similarly, the outfeed table 170 can further include at least one outfeed post bracket 177 (which is also referred to herein as an “outfeed leg bracket”) and at least one post 179 (which is also referred to herein as a “leg”) configured to support the outfeed table surface 172. The outfeed post bracket 177 can include apertures configured to receive fasteners that couple the outfeed post bracket 177 to the rest of the outfeed table 170.

The guttering assembly 200 can include at least one trough support 210 (which is also referred to herein as a “trough support bracket” and/or “trough bracket”) coupled to a corresponding one of the infeed post brackets 167 or the outfeed post brackets 177. The guttering assembly 200 can further include at least one trough piece 220 (which is also referred to herein as a “trough segment” and/or “trough”) extending between adjacent trough supports 210 or between one of the trough supports 210 and the adjacent saw table 110.

During operation, coolant can be sprayed onto the workpiece and/or the saw blade 132. In some examples, some of the sprayed coolant may drip onto the infeed table surface 162 and/or the outfeed table surface 172. Additionally or alternatively, excess coolant may be inadvertently sprayed onto the infeed table surface 162 and/or the outfeed table surface 172. The coolant that collects on the infeed table surface 162 and/or the outfeed table surface 172 can drain into the trough support 210 and/or the trough piece 220 disposed underneath the infeed table surface 162 and/or the outfeed table surface 172. The collected coolant can flow along the trough support(s) 210 and the trough piece(s) 220 into the coolant reservoir of the saw table 110. Accordingly, the trough formed by the trough support(s) 210 and the trough piece(s) 220 is fluidly coupled to the coolant reservoir of the saw table 110.

In some examples, the trough support(s) 210 and the trough piece(s) 220 can be arranged to downwardly slope toward the saw table 110. In some examples, the trough support(s) 210 and the trough piece(s) 220 do not slope toward the saw table 110. For example, the trough support(s) 210 and the trough piece(s) 220 can be level.

Although FIG. 20 shows the guttering assembly 200 disposed underneath both the infeed table 160 and the outfeed table 170, it should be understood that the guttering assembly 200 can be disposed under just the infeed table 160 or just the outfeed table 170. It should further be understood that although the following description is made with reference to the infeed table 160, the guttering assembly 200 can be installed or coupled in a similar manner to the outfeed table 170. Accordingly, since the guttering assembly 200 is compatible with both the infeed table 160 and the outfeed table 170, the following description of the guttering assembly 200 may generically refer to the infeed table 160 and the outfeed table 170 as “tables,” the infeed table surface 162 and the outfeed table surface 172 as “table surfaces,” and the infeed post brackets 167 and the outfeed post brackets 177 as “post brackets.”

FIG. 20 calls out in dashed lines a first portion 2100, a second portion 2200, and a third portion 2300 of the guttering assembly 200. The first portion 2100 can be a portion of the guttering assembly 200 that is coupled to the infeed post bracket 167 furthest from the saw table 110. The second portion 2200 can be a portion coupled to an intermediate one of the infeed post brackets 167. The third portion 2300 can be a portion coupled to the infeed post bracket 167 closest to the saw table 110.

FIG. 21 is a perspective view of the first portion 2100 of the guttering assembly 200. The first portion 2100 includes the trough support 210 coupled to the post bracket 167, one trough piece 220 coupled to and partially overlapping an end portion of the trough support 210, a back trough bracket 230 coupled to the post bracket 167, and an end cap 240 coupled to the trough support 210.

As shown, the trough support 210 can include a first plate 212, a second plate 214, a cutout 216 in the first plate 212, and a vertical flange 213 extending from the first plate 212 adjacent the cutout 216. As further shown, the first plate 212 and the second plate 214 are joined to form a “V”-shaped trough (in other words, a trough having a “V”-shaped cross-section). However, in some examples, the trough support 210 can be configured to form a flat-bottomed trough, a half-round trough, a valley trough, or any other shaped trough. In some examples, a width 221 of the trough (in other words, a shortest straight-line distance between the lateral sides of the trough) can be greater than or equal to a width of the cutting envelope of the cold saw system 100. In some examples where the cutting envelope is adjustable, the width 221 of the trough can be greater than or equal to a maximum width of the cutting envelope. In such examples, configuring the trough to be at least as wide as the cutting envelope can help ensure that coolant dripping off the workpiece drains into the trough.

The trough support 210 is coupled to the post bracket 167. For example, as shown, a portion of the post bracket 167 can extend through the cutout 216 and can be coupled to the vertical flange 213 of the trough support 210 using one or more fasteners 218.

In some examples, the trough support 210 can further include a vertical lip 215. For example, as shown, the vertical lip 215 can extend from a lateral edge portion of the second plate 214. Additionally or alternatively, the trough support 210 can include a vertical lip extending from a lateral edge portion of the first plate 212.

The trough piece 220 is coupled to and partially overlaps the trough support 210. The trough piece 220 includes a first plate 222 and second plate 224 that are joined to form a “V”-shaped trough. However, the trough piece 220 can be configured to form a flat-bottomed trough, a half-round trough, a valley trough, or any other trough to match the shape of the trough formed by the trough support 210. As shown, the trough piece 220 includes a vertical lip 225 extending from a lateral portion of the second plate 224. Additionally or alternatively, the trough piece 220 can include a vertical lip extending from a lateral edge portion of the first plate 222.

The trough support 210 and the trough piece 220 can be coupled together using fasteners 217. As shown, fastener 217a can couple the first plate 212 of the trough support 210 and the first plate 222 of the trough piece 220. As further shown, fastener 217b can additionally or alternatively couple the lip 215 of the trough support 210 and the lip 225 of the trough piece 220. In some examples, another fastener can additionally or alternatively couple the second plate 214 of the trough support 210 and the second plate 224 of the trough piece 220. As such, the trough piece(s) 220 and the trough support(s) 210 can be coupled together to form a continuous trough that extends along at least a partial length of the infeed table 160 and/or the outfeed table 170.

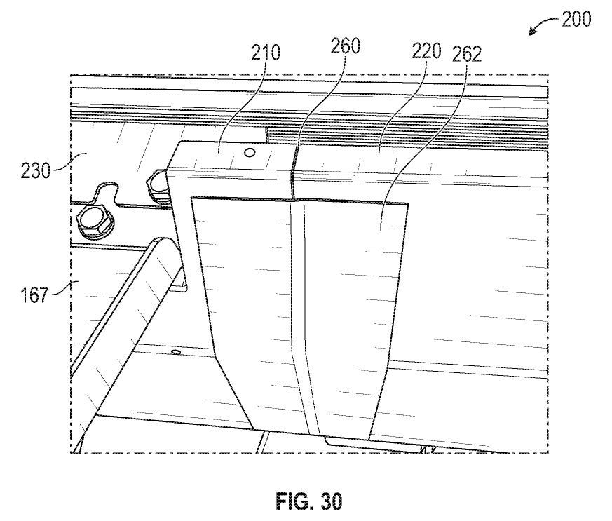

When coupled together, the trough support 210 and the trough piece 220 form a seam 260 which can be sealed using epoxy, caulk (for example, weather-resistant flexible caulk), gaskets, tape, or any combination thereof to prevent coolant from leaking therethrough. For example, as shown in FIG. 30, the seam 260 can be sealed using weather-resistant flexible caulk applied to the seam 260 and tape 262 placed over the seam 260.

Now referring back to FIG. 21, the guttering assembly 200 further includes the back trough bracket 230 (which is also referred to herein as a “flow deflector bracket”) coupled to the post bracket 167. The back trough bracket 230 is configured to deflect coolant that would otherwise flow through the cutout 216 into the trough. As shown, the vertical flange 213 can be coupled to a first side (for example, a front side) of the post bracket 167 and the back trough bracket 230 can be coupled to a second side (for example, a “back” side) of the post bracket 167.

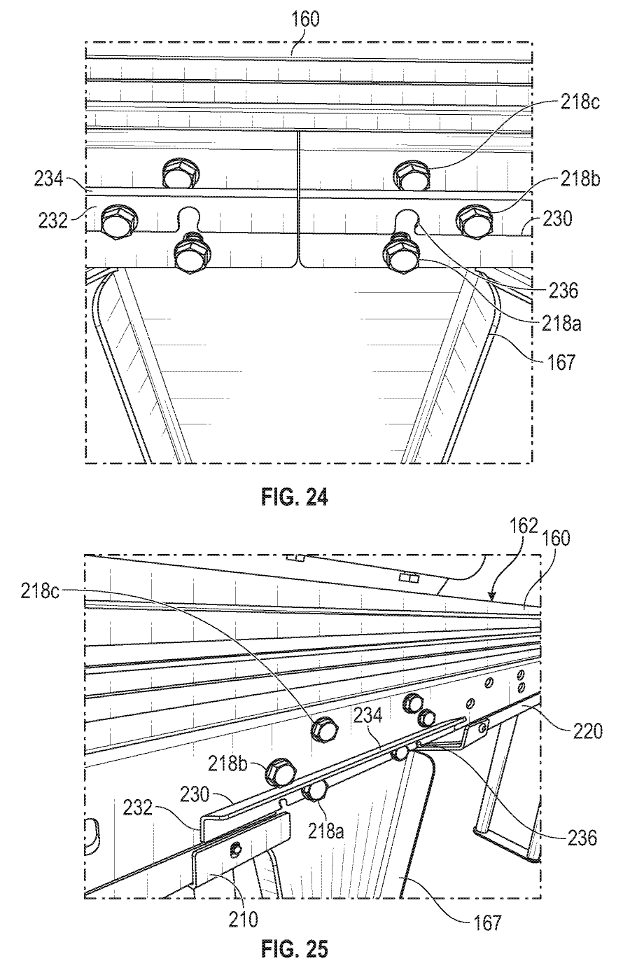

Now referring to FIGS. 24-25, which show perspective views of the back trough bracket 230, the back trough bracket 230 can include a vertical flange 232 coupled to an angled flange 234. The vertical flange 232 is configured to rest flush against the infeed post bracket 167 (or the outfeed post bracket 177) and, as best shown in FIG. 25, the angled flange 234 is configured to extend from the vertical flange 232 in both a lateral direction and an upward direction, such that the infeed post bracket 167 and the angled flange 234 form a gutter, trough, or channel therebetween. As further shown in FIG. 25, the length of the angled flange 234 is longer than the length of the cutout 216 such that the ends of the angled flange 234 overlap the trough support 210. This allows coolant falling onto the angled flange 234 to be channeled away from the cutout 216 and into the trough formed by the trough support 210.

As further shown in FIGS. 24-25, the post bracket 167 is coupled to the rest of the infeed table using fasteners 218a, 218b, 218c. The fasteners 218a, 218b, 218c are arranged into three vertical rows, with fasteners 218a disposed below fasteners 218b and fasteners 218b disposed below fasteners 218c. The vertical flange 232 includes cutouts 236 which are configured to receive any of the fasteners 218a, 218b, 218c. For example, as shown in FIG. 24, fasteners 218b can be inserted through the cutouts 236 to couple the back trough bracket 230 to the infeed table 160. As further shown in FIG. 25, fasteners 218a can be inserted through the cutouts 236 to couple the back trough bracket 230 to the infeed table 160. Alternatively, fasteners 218c can be inserted through the cutouts 236 to couple the back trough bracket 230 to the infeed table 160.

Now referring back to FIG. 21, the guttering assembly 200 further includes the end cap 240 coupled to the trough support 210. The end cap 240 can help prevent coolant from flowing past the end of the trough support 210. The end cap 240 can be coupled to the trough support 210 using fasteners 242.

FIGS. 22-23 are perspective views of the second and third portions 2200, 2300 of the guttering assembly 200, respectively. The second and third portions 2200, 2300 also include the trough support 210, at least one trough piece 220, and the back trough bracket 230. One exemplary difference between the first portion 2100 and the second and third portions 2200, 2300 is that the second and third portions 2200, 2300 each include two trough pieces 220 that overlap opposite longitudinal end portions of the trough support 210. Another exemplary difference is that the second and third portions 2200, 2300 lack the end cap 240.

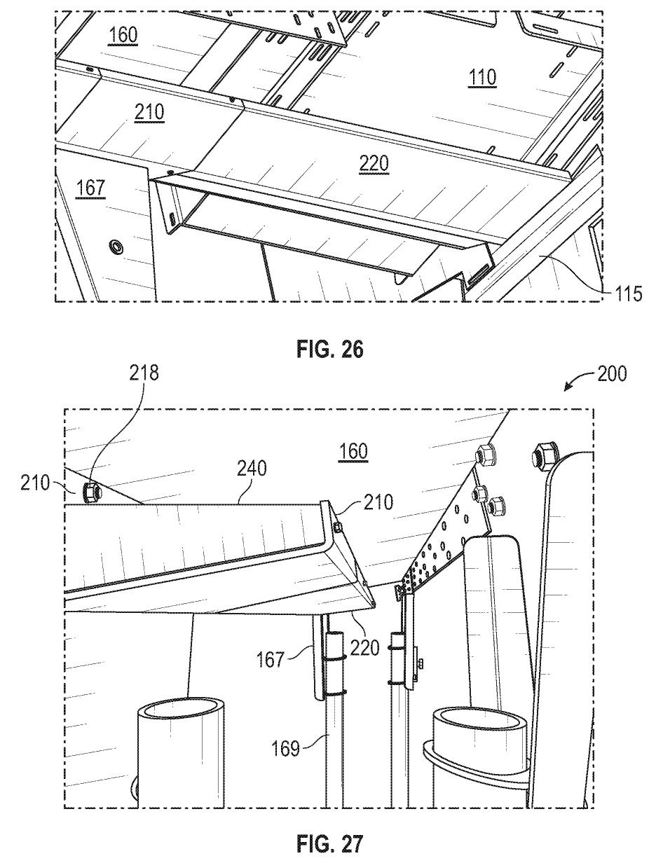

FIG. 26 is a bottom-up perspective view of a portion of the saw table 110, the infeed table 160, and the guttering assembly 200. The illustrated trough piece 220 is disposed underneath the infeed table 160. As shown, a first end portion of the trough piece 220 is coupled to and overlaps an end portion of the trough support 210 and a second, opposite end portion of the trough piece 220 is coupled to and overlaps a lip 115 of the saw table 110. The lip 115 can be adjacent an opening of the coolant reservoir. As such, coolant that drains from the infeed table 160 into the guttering assembly 200 can flow along the trough support 210, along the trough piece 220, and into the coolant reservoir of the saw table 110.

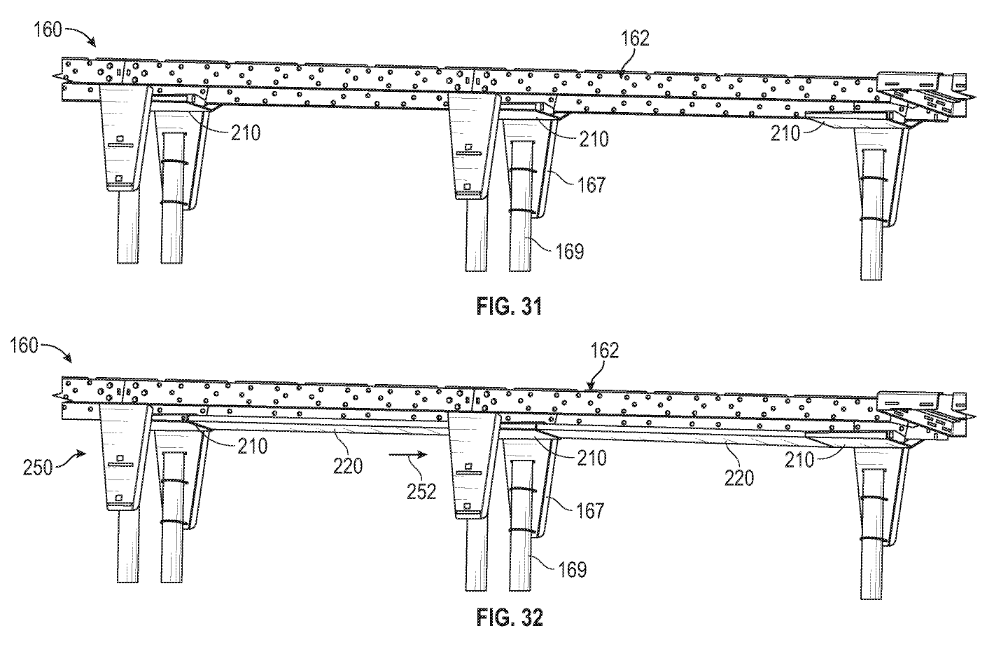

FIGS. 31-32 illustrate a process of installing the guttering assembly 200 on the infeed table 160. The guttering assembly 200 can be coupled to the infeed table 160 during an initial assembly of the cold saw system 100 or during a retrofit of an existing cold saw system 100.

FIG. 31 is a side view of the infeed table 160 and the guttering assembly 200 during a first stage of the guttering assembly installation process. The first stage can include coupling the trough supports 210 to corresponding ones of the infeed post brackets 167. Each trough support 210 can be coupled to its corresponding infeed post bracket 167 by aligning the infeed post bracket 167 with the cutout 216 of the trough support 210 and fastening the vertical flange 213 of the trough support 210 to the infeed post bracket 167 using fasteners 218 (FIG. 21). In some examples where the guttering assembly 200 is retrofitted on an existing cold saw system 100, the first stage can further include decoupling the infeed post brackets 167 from the rest of the infeed table 160 prior to aligning the infeed post brackets 167 with the cutouts 216.

FIG. 32 is a side view of the infeed table 160 and the guttering assembly 200 during a second stage of the guttering assembly installation process. The trough pieces 220 can be slid under a front 250 of the infeed table 160 and in the direction of arrow 252 over the trough supports 210. The longitudinal end portions of the trough pieces 220 can then be aligned with corresponding longitudinal end portions of the trough supports 210, and the trough pieces can be coupled to the trough supports 210 using fasteners 217 (FIG. 21).

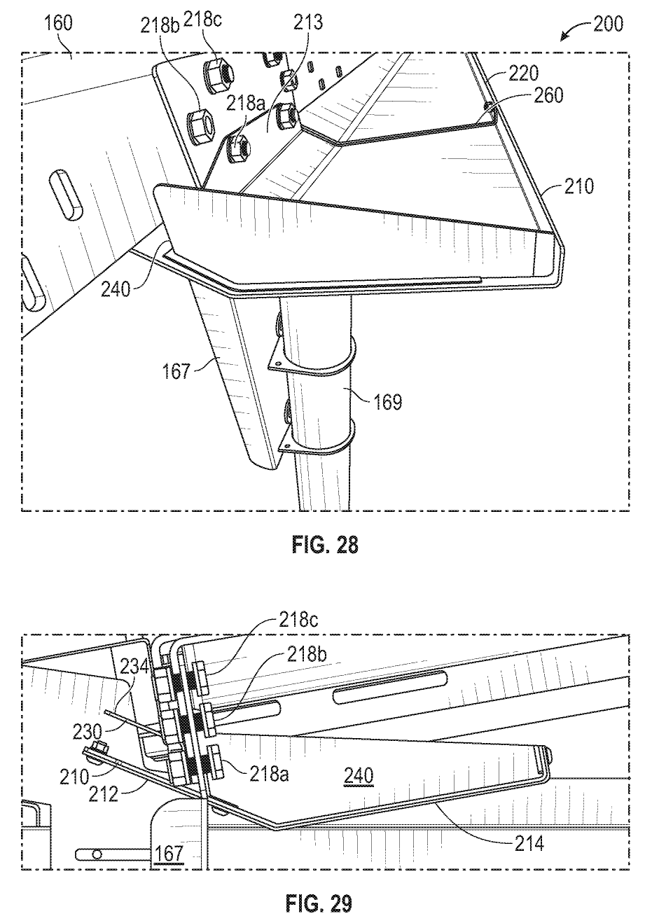

Thereafter, the seams 260 between the trough supports 210 and trough pieces 220 can be sealed (for example, using caulk and tape 262 as shown in FIG. 30), the back trough brackets 230 can be coupled to the infeed post brackets 167 as shown in FIGS. 24-25, and the end cap 240 can be installed on the front-most trough support 210 using fasteners 242 as shown in FIGS. 21 and 28-29.

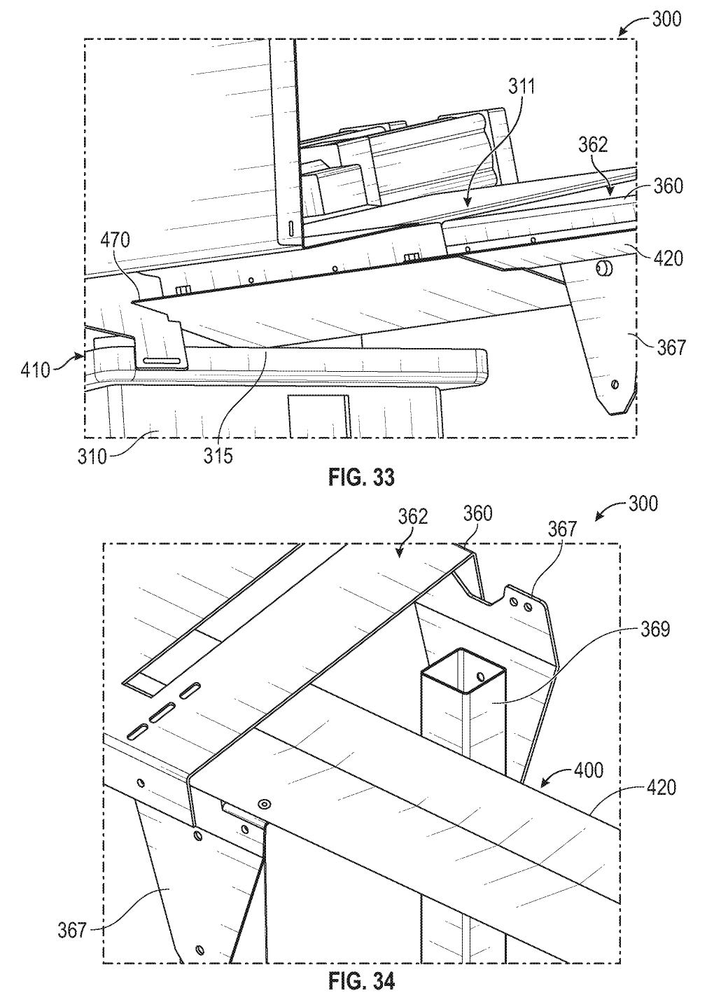

FIGS. 33-36 illustrate a cold saw system 300, according to another example. The cold saw system 300 can share certain similar features with the cold saw system 100, and these similar features can be referred to by reference numbers offset by hundreds. For example, the cold saw system 300 includes a saw table 310 that can share certain similarities with the saw table 110 and an infeed table 360 that can share certain similarities with the infeed table 160. The saw table 310 can include a table surface 311 and a lip 315 beneath the table surface 311. The lip 315 can be adjacent an opening of a coolant reservoir of the saw table 310. The infeed table 360 can include an infeed table surface 362 and a plurality of infeed post brackets 367 and posts 369 supporting the infeed table surface 362. The cold saw system 300 can further include an outfeed table (not shown) with an outfeed table surface.

The cold saw system 300 can further include a guttering assembly 400 configured to collect coolant that drains off the infeed table surface 362 and/or the outfeed table surface and channel the collected coolant into a coolant reservoir of the saw table 310. As best shown in FIGS. 33 and 34, one exemplary difference between the guttering assembly 400 and the previously illustrated guttering assembly 200 of FIGS. 20-32 is that the guttering assembly 400 can have a two-trough design including a first trough piece 420 (which is also referred to herein as an “upper trough piece”) and a second trough piece 470 (which is also referred to herein as a “lower trough piece”) disposed below the first trough piece 420.

In some examples, the dimensions of the saw table 310 and the infeed table 360 do not allow for the first trough piece 420 to be aligned with the opening of the coolant reservoir of the saw table 310. Thus, coolant collected in the first trough piece 420 cannot easily drain into the coolant reservoir. Accordingly, the second trough piece 470 can be disposed underneath a longitudinal end portion of the first trough piece 420 and aligned with the opening of the coolant reservoir, thereby allowing coolant collected by the first trough 420 to fall into the second trough piece 470 and subsequently drain into the coolant reservoir. Accordingly, the first trough piece 420 is indirectly fluidly coupled via the second trough piece 470 to the coolant reservoir.

Now referring to FIG. 33, the first trough piece 420 can be longer than the second trough piece 470. For example, the first trough piece 420 can extend along an entire length of the infeed table 360 or along a substantial length of the infeed table 360 to collect coolant draining off the infeed table surface 362. The second trough piece 470 extends only between the saw table 310 and a nearest one of the infeed post brackets 367, such that the longitudinal end portion of the first trough piece 420 overlaps the second trough piece 470.

Now referring to FIG. 34, the first trough piece 420 can be coupled to a lip 373 of the infeed post bracket 367.

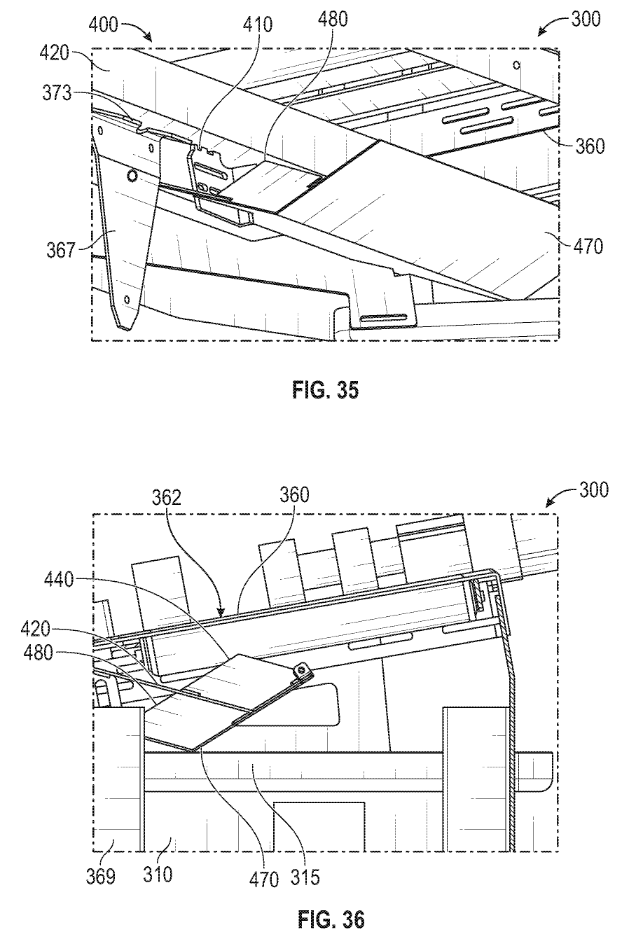

Now referring to FIG. 35, the guttering assembly 400 further includes a second trough support 410 (which is also referred to herein as a “second trough bracket” and/or a “second trough support bracket”). The second trough support 410 couples the second trough piece 470 to a bottom of the infeed table 360.

Now referring to FIG. 36, the guttering assembly 400 can include a first end cap 440 coupled to a longitudinal end portion of the first trough piece 420 and a second end cap 480 coupled to a longitudinal end portion of the second trough piece 470. The end caps 440, 480 can help prevent coolant from flowing past the ends of the first and second trough pieces 420, 470.

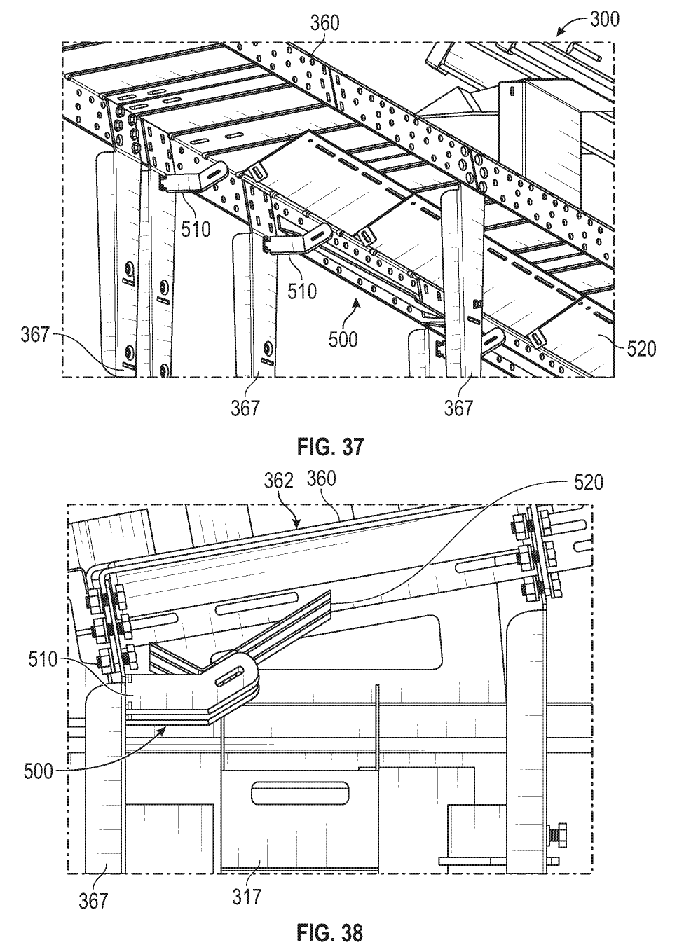

FIGS. 37-39 illustrate a guttering assembly 500 for the cold saw system 300, according to another example. The guttering assembly 500 includes a plurality of trough supports 510 (which are also referred to herein as “trough brackets” and/or “trough support brackets”)coupled to lateral sides of the infeed post brackets 367. The guttering assembly 500 further includes trough pieces 520 coupled to and extending between adjacent trough supports 510. Each trough piece 520 can overlap a portion of an adjacent trough piece 520 to form a continuous trough extending underneath the infeed table 360.

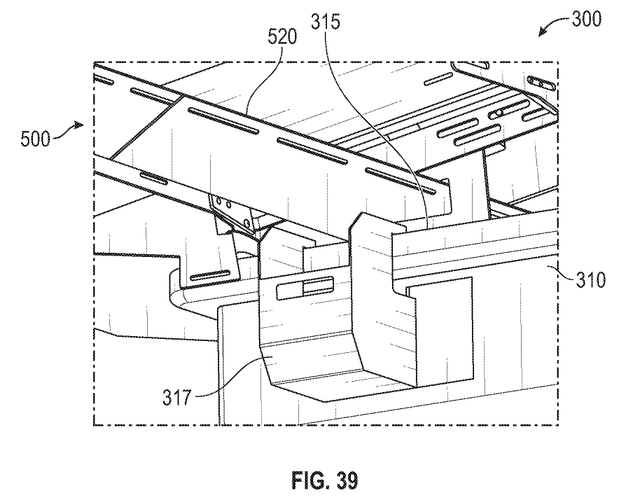

As shown in FIGS. 38-39, the cold saw system 300 can include an outside coolant reservoir 317. The outside coolant reservoir 317 can be a container configured to hold coolant coupled to the outside of the saw table 310. For example, the outside reservoir 317 can hang from the lip 315 of the saw table 310. In some examples where the longitudinal end portion of the trough piece 520 does not align with the opening of the coolant reservoir within the saw table 310, coolant collected in the trough piece 520 can drain into the outside coolant reservoir 317, and the coolant in the outside coolant reservoir 317 can be pumped into the coolant reservoir inside the saw table 310. However, in some examples, the trough piece 520 nearest the saw table 310 can rest on the lip 315 of the saw table 310 adjacent the opening of the coolant reservoir, which allows coolant collected in the trough piece 520 to drain into the coolant reservoir inside the saw table 310.

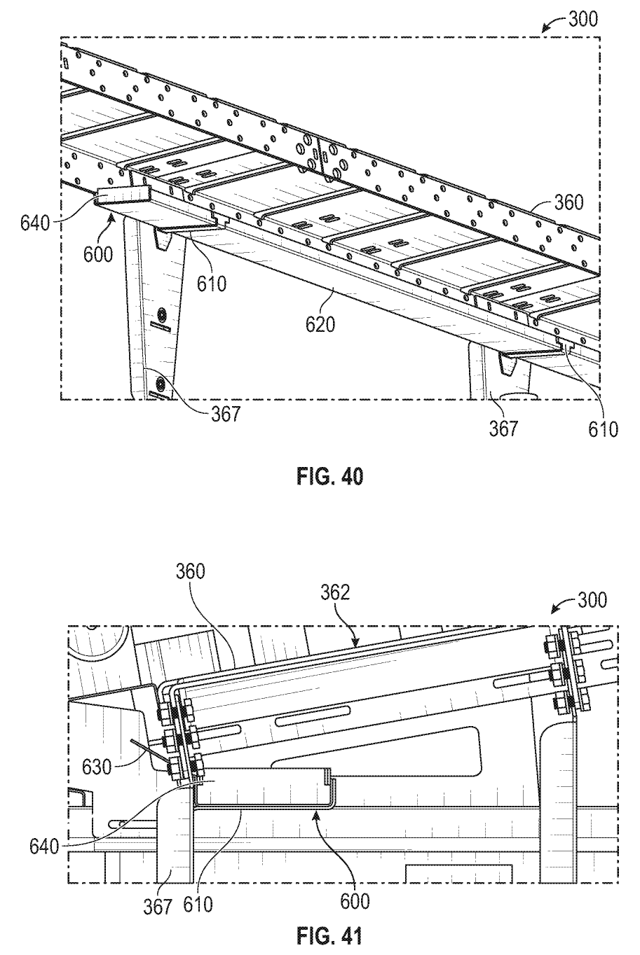

FIGS. 40-41 illustrate a guttering assembly 600 for the cold saw system 300, according to another example. The guttering assembly 600 includes a plurality of trough supports 610 (which are also referred to herein as “trough brackets” and/or “trough support brackets”) coupled to lateral sides of the infeed post brackets 367.

The guttering assembly 600 further includes a trough piece 620 coupled to and extending between the trough supports 610. One exemplary difference between the trough piece 620 and the previously illustrated trough pieces 220, 420, 520 is that the trough piece 620 has a flat bottom.

In some examples, any of the trough pieces 220, 420, 520, 620 described herein can be implemented as a single trough piece or as a plurality of trough pieces coupled together to form a continuous trough.

Now referring to FIG. 41, the guttering assembly 600 further includes back trough brackets 630 (which is also referred to herein as a “flow deflector bracket”) coupled to the lateral sides of the infeed post brackets 367. The back trough brackets 230 are configured to capture coolant flowing over the lateral sides of the infeed table surface 362 and direct the coolant into the trough formed by the trough piece 620.

The guttering assembly 600 further includes an end cap 640 coupled to the trough piece 620.

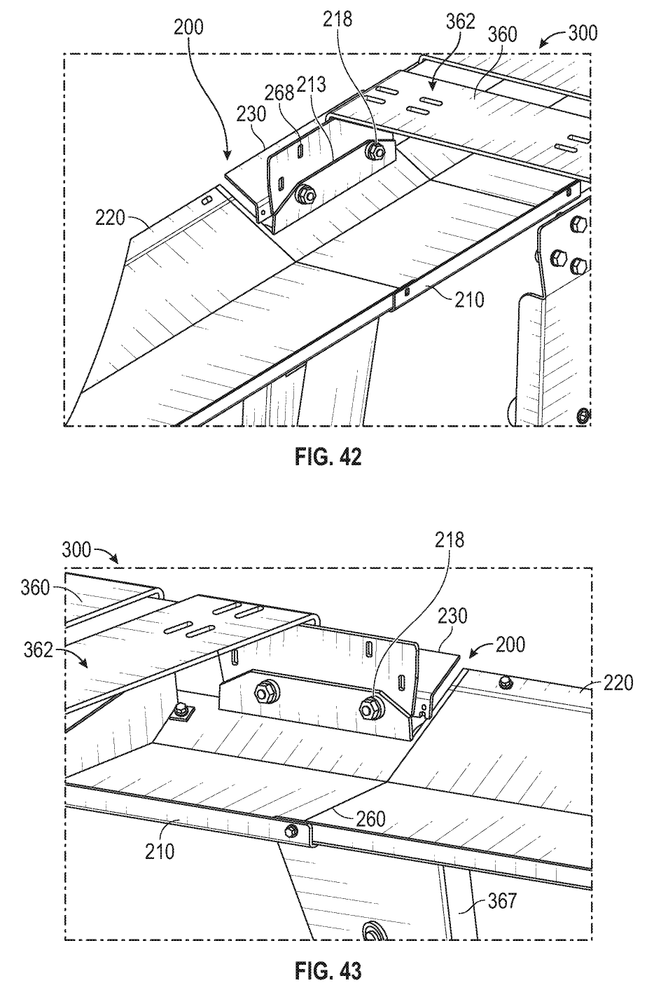

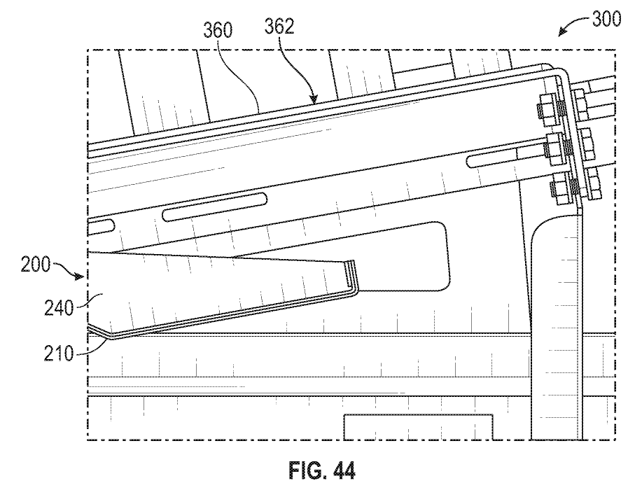

FIGS. 42-44 illustrate the guttering assembly 200 installed on the cold saw system 300. Any of the guttering assemblies 200, 400, 500, 600 disclosed herein can be compatible with any of the cold saw systems 100, 300 disclosed herein.

### Examples of the Disclosed Technology

In view of the above-described implementations of the disclosed subject matter, this application discloses the additional examples enumerated below. It should be noted that one feature of an example in isolation or more than one feature of the example taken in combination and, optionally, in combination with one or more features of one or more further examples are further examples also falling within the disclosure of this application.

Example 1. A system can include a saw table defining a table surface; a saw cabinet mounted on the saw table, wherein the saw cabinet can include a top surface and an aperture in the top surface; a damper extending at least partially through the aperture; a saw coupled to the damper and disposed within the saw cabinet; a clamp configured to releasably engage a workpiece disposed on the table surface of the saw table; at least one of an infeed table defining an infeed table surface, wherein the infeed table surface can be coplanar with the table surface of the saw table, and an outfeed table defining an outfeed table surface, wherein the outfeed table surface can be coplanar with the table surface of the saw table; and a controller storing instructions in non-transitory memory that, when executed, can cause the controller to: engage the clamp; advance the saw from a resting position to a cutting position; retract the saw from the cutting position to the resting position; and disengage the clamp.

Example 2. The system of any example herein, particularly Example 1, wherein advancing the saw from the resting position to the cutting position can include advancing the saw past a damper activation position, and wherein advancing the saw past the damper activation position engages the damper.

Example 3. The system of any example herein, particularly Example 2, wherein: the saw can be advanced at a first rate between the resting position and the damper activation position, the saw can be advanced at a second rate between the damper activation position and the cutting position, and wherein the first rate can be greater than the second rate.

Example 4. The system of any example herein, particularly any one of Examples 2-3, wherein the damper can include a threaded rod and a nut coupled to the threaded rod, wherein moving the nut relative to the threaded rod can change a location of the damper activation position.

Example 5. The system of any example herein, particularly any one of Examples 1-4, wherein the saw cabinet can be configured to prevent a user from reaching the saw when the system is in operation.

Example 6. The system of any example herein, particularly any one of Examples 1-5, wherein the system can be configured to rest upon a ground surface, and wherein at least one of the infeed table surface and the outfeed table surface can be tilted relative to the ground surface.

Example 7. The system of any example herein, particularly any one of Examples 1-6, which can further include an emergency pull line assembly, wherein: the emergency pull line assembly can include a pull line extending along a length of one of the infeed table and the outfeed table, and the emergency pull line assembly can be configured to stop the operation of the system when the pull line is pulled.

Example 8. The system of any example herein, particularly any one of Examples 1-7, wherein: the saw table can include a slot in the table surface, a coolant strainer fluidly coupled to the slot, and a coolant reservoir fluidly coupled to the coolant strainer, and the system can further include a nozzle fluidly coupled to the coolant reservoir and configured to spray coolant onto at least the saw.

Example 9. The system of any example herein, particularly any one of Examples 1-8, wherein the saw cabinet can include a guard door and a mechanical interlock switch configured to prevent the operation of the saw when the guard door is open.

Example 10. The system of any example herein, particularly any one of Examples 1-9, wherein the infeed table can include a push feeder with a push feeder carriage and a motor coupled to the controller, and wherein the controller can store instructions in non-transitory memory that, when executed, cause the push feeder to advance along a length of the infeed table.

Example 11. A system can include a saw table defining a table surface; a saw cabinet coupled to the saw table; a damper coupled to the saw cabinet; a saw coupled to the damper and disposed within the saw cabinet; and a controller storing instructions in non-transitory memory that, when executed, can cause the controller to: advance the saw from a resting position to a damper activation position; and advance the saw from the damper activation position to a cutting position.

Example 12. The system of any example herein, particularly Example 11, wherein advancing the saw from the resting position to the damper activation position can include advancing the saw at a first rate, and wherein advancing the saw from the damper activation position to the cutting position can include advancing the saw at a second rate.

Example 13. The system of any example herein, particularly Example 12, wherein the first rate can be greater than the second rate.

Example 14. A system can include a saw table defining a table surface; a saw cabinet coupled to the saw table; a damper coupled to the saw cabinet; a saw coupled to the damper and disposed within the saw cabinet; and a controller storing instructions in non-transitory memory that, when executed, can cause the controller to: advance the saw from a resting position to an intermediate position at a first rate; advance the saw from the intermediate position to a cutting position at a second rate; and retract the saw from the cutting position to the resting position.

Example 15. The system of any example herein, particularly Example 14, which can further include a clamp configured to releasably engage a workpiece disposed on the table surface of the saw table.

Example 16. The system of any example herein, particularly Example 15, wherein the controller can store further instructions in non-transitory memory that, when executed, can cause the controller to: receive a saw on delay; engage the clamp; and activate the saw once the saw on delay has elapsed.

Example 17. The system of any example herein, particularly any one of Examples 15-16, which can further a sensor configured to detect whether the saw is in the resting position, wherein the controller can store further instructions in non-transitory memory that, when executed, can cause the controller to: receive a clamp off delay; receive a signal from the sensor indicating that the saw has been retracted to the resting position; and disengage the clamp after the clamp off delay has elapsed.

Example 18. The system of any example herein, particularly any one of Examples 14-17, wherein the controller can store further instructions in non-transitory memory that, when executed, can cause the controller to receive a part list comprising one or more instructions to operate the saw to make a cut in material.

Example 19. The system of any example herein, particularly Example 18, wherein the part list can be one of a pusher list, a set point list, a pattern list, and a pull list.

Example 20. The system of any example herein, particularly any one of Examples 14-19, wherein the controller can include a first user interface and a second user interface, wherein the second user interface is configured to cover the first user interface.

Example 21. The system of any example herein, particularly any one of Examples 14-20, wherein the saw can be configured to cut a ferrous material.

Example 22. A system can include a saw table defining a saw table surface and having a coolant reservoir; a saw coupled to the saw table; a table defining a table surface and having a plurality of post brackets, wherein the table surface can be coplanar with the saw table surface; a guttering assembly coupled to the table, wherein the guttering assembly can include a trough support coupled to a corresponding one of the post brackets and a trough piece coupled to the trough support. The trough piece can form a trough configured to collect coolant draining off the table surface and channel the coolant to the coolant reservoir.

Example 23. The system of any example herein, particularly Example 22, wherein the trough support can include a first plate and a second plate joined to form a “V”-shaped trough.

Example 24. The system of any example herein, particularly any one of Examples 22-23, wherein the trough support can further include a cutout in the first plate and a vertical flange extending from the first plate adjacent the cutout, wherein the cutout can receive a portion of the corresponding one of the post brackets, and wherein the vertical flange can be coupled to a first lateral side of the post bracket.

Example 25. The system of any example herein, particularly Example 24, wherein the guttering assembly can further include a back trough bracket coupled to a second lateral side of the post bracket, and wherein the back trough bracket can be configured to channel coolant draining off the table surface away from the cutout.

Example 26. The system of any example herein, particularly Example 25, wherein the back trough bracket can include a vertical flange and an angled flange extending in a lateral direction and an upward direction from the vertical flange.

Example 27. The system of any example herein, particularly any one of Examples 22-26, wherein the trough piece can extend between the trough support and a lip of the saw table, and wherein the lip can be adjacent an opening of the coolant reservoir.

Example 28. The system of any example herein, particularly any one of Examples 22-26, wherein the trough piece can be a first trough piece, wherein the system can further include a second trough piece disposed below the first trough piece, and wherein the second trough piece can extend to a lip of the saw table adjacent an opening of the coolant reservoir.

Example 29. The system of any example herein, particularly any one of Examples 22-28, wherein the system can further include a nozzle fluidly coupled to the coolant reservoir, and wherein the nozzle can be configured to spray coolant onto at least the saw.

Example 30. The system of any example herein, particularly any one of Examples 22-29, which can further include an outside coolant reservoir coupled to the saw table.

Example 31. The system of any example herein, particularly any one of Examples 22-30, wherein the table can be an infeed table.

Example 32. The system of any example herein, particularly any one of Examples 22-30, wherein the table can be an outfeed table.

Example 33. A guttering assembly for a cold saw system can include a plurality of trough support brackets, a plurality of trough segments, and a plurality of back trough brackets. Each trough support bracket can be configured to be coupled to a corresponding post bracket of a table of the cold saw system. Each trough segment can be configured to extend underneath a table surface of the table between adjacent ones of the trough support brackets. Each back trough bracket can be configured to be coupled to a corresponding post bracket.

Example 34. The system of any example herein, particularly Example 33, wherein each trough segment can form a “V”-shaped trough.

Example 35. The system of any example herein, particularly Example 33, wherein each trough segment can form a flat-bottomed trough.

Example 36. The system of any example herein, particularly any one of Examples 33-35, wherein each trough support bracket can include a first plate, a second plate, a cutout in the first plate, and a vertical flange extending from the first plate adjacent the cutout.

Example 37. The system of any example herein, particularly Example 36, wherein the cutout can be configured to receive a portion of the corresponding post bracket, and wherein the vertical flange can be configured to be coupled to a first lateral side of the corresponding post bracket.

Example 38. The system of any example herein, particularly any one of Examples 36-37, wherein each back trough bracket can be configured to be coupled to a second lateral side of the corresponding post bracket.

Example 39. The system of any example herein, particularly any one of Examples 36-38, wherein the first plate and the second plate of each trough support bracket can be joined to form a “V”-shaped trough.

Example 40. The system of any example herein, particularly any one of Examples 33-39, which can further include an end cap configured to be coupled to a longitudinal end portion of the at least one trough segment.

Example 41. A method of assembling a cold saw system can include coupling a plurality of trough support brackets to corresponding ones of a plurality of post brackets of a table of the cold saw system, coupling a plurality of trough segments to the plurality of trough support brackets to form a trough, and fluidly coupling the trough to a coolant reservoir of the cold saw system.

Example 42. A method or system of any example herein, wherein the saw is a circular saw.

Example 43. A method or system of any example herein, wherein the saw is a band saw.

Example 44. A method or system of any example herein, wherein coolant draining off the table surface includes coolant that drains through one or more gaps, apertures, or openings formed in the table surface, including gaps positioned within a cutting envelope through which a workpiece is configured to move or be push-fed, and wherein the guttering assembly is configured to receive coolant draining through the gaps and channel the coolant to the coolant reservoir.

The features described herein with regard to any example can be combined with other features described in any one or more of the other examples, unless otherwise stated. For example, any one or more of the features of one cold saw system can be combined with any one or more features of another cold saw system. Additionally or alternatively, any one or more features of one guttering assembly can be combined with any one or more features of another guttering assembly.

In view of the many possible ways in which the principles of the disclosure may be applied, it should be recognized that the illustrated configurations depict examples of the disclosed technology and should not be taken as limiting the scope of the disclosure nor the claims. Rather, the scope of the claimed subject matter is defined by the following claims and their equivalents.

1. A system comprising:
a saw table defining a saw table surface and comprising a coolant reservoir;
a saw coupled to the saw table;
a table defining a table surface and comprising a plurality of post brackets, wherein the table surface is coplanar with the saw table surface;
a guttering assembly coupled to the table, wherein the guttering assembly comprises:
a trough support coupled to a corresponding one of the post brackets; and
a trough piece coupled to the trough support,
wherein the trough piece forms a trough configured to collect coolant draining off the table surface and channel the coolant to the coolant reservoir.

2. The system of claim 1, wherein the trough support comprises a first plate and a second plate joined to form a “V”-shaped trough.

3. The system of claim 2, wherein the trough support further comprises a cutout in the first plate and a vertical flange extending from the first plate adjacent the cutout, wherein the cutout receives a portion of the corresponding one of the post brackets, and wherein the vertical flange is coupled to a first lateral side of the post bracket.

4. The system of claim 3, wherein the guttering assembly further comprises a back trough bracket coupled to a second lateral side of the post bracket, and wherein the back trough bracket is configured to channel coolant draining off the table surface away from the cutout.

5. The system of claim 4, wherein the back trough bracket comprises a vertical flange and an angled flange extending in a lateral direction and an upward direction from the vertical flange.

6. The system of claim 1, wherein the trough piece extends between the trough support and a lip of the saw table, and wherein the lip is adjacent an opening of the coolant reservoir.

7. The system of claim 1, wherein the trough piece is a first trough piece, wherein the system further comprises a second trough piece disposed below the first trough piece, and wherein the second trough piece extends to a lip of the saw table adjacent an opening of the coolant reservoir.

8. The system of claim 1, wherein the system further comprises a nozzle fluidly coupled to the coolant reservoir, and wherein the nozzle is configured to spray coolant onto at least the saw.

9. The system of claim 1, further comprising an outside coolant reservoir coupled to the saw table.

10. The system of claim 1, wherein the table is an infeed table.

11. The system of claim 1, wherein coolant draining off the table surface includes coolant that drains through one or more gaps, apertures, or openings formed in the table surface, including gaps positioned within a cutting envelope through which a workpiece is configured to move or be push-fed, and wherein the guttering assembly is configured to receive coolant draining through the gaps and channel the coolant to the coolant reservoir.

12. A guttering assembly for a cold saw system comprising:
a plurality of trough support brackets, wherein each trough support bracket is configured to be coupled to a corresponding post bracket of a table of the cold saw system;
at least one trough segment, wherein each trough segment is configured to extend underneath a table surface of the table between adjacent ones of the trough support brackets; and
a plurality of back trough brackets, wherein each back trough bracket is configured to be coupled to a corresponding post bracket.

13. The guttering assembly of claim 12, wherein each trough segment forms a “V”-shaped trough.

14. The guttering assembly of claim 12, wherein each trough segment forms a flat-bottomed trough.

15. The guttering assembly of claim 12, wherein each trough support bracket comprises a first plate, a second plate, a cutout in the first plate, and a vertical flange extending from the first plate adjacent the cutout.

16. The guttering assembly of claim 15, wherein the cutout is configured to receive a portion of the corresponding post bracket, and wherein the vertical flange is configured to be coupled to a first lateral side of the corresponding post bracket.

17. The guttering assembly of claim 16, wherein each back trough bracket is configured to be coupled to a second lateral side of the corresponding post bracket.

18. The guttering assembly of claim 15, wherein the first plate and the second plate of each trough support bracket are joined to form a “V”-shaped trough.

19. The guttering assembly of claim 12, further comprising an end cap configured to be coupled to a longitudinal end portion of the at least one trough segment.

20. A method of assembling a cold saw system comprising:
coupling a plurality of trough support brackets to corresponding ones of a plurality of post brackets of a table of the cold saw system;
coupling a plurality of trough segments to the plurality of trough support brackets to form a trough; and
fluidly coupling the trough to a coolant reservoir of the cold saw system.
